(19) United States
(12) Patent Application Publication
(10) Pub. No.: US 2021/0257666 A1
(43) Pub. Date: Aug. 19, 2021

(54) TERNARY SOLVENT PACKAGE FOR LITHIUM-SULFUR BATTERIES

(71) Applicant: Lyten, Inc., San Jose, CA (US)

(72) Inventors: Qianwen Huang, San Jose, CA (US); Elena Rogojina, San Jose, CA (US); Jerzy Gazda, Austin, TX (US); Anurag Kumar, Sunnyvale, CA (US); Jeffrey Bell, Santa Clara, CA (US); Jesse Baucom, Sunnyvale, CA (US); You Li, Sunnyvale, CA (US)

(73) Assignee: Lyten, Inc., San Jose, CA (US)

(21) Appl. No.: 17/236,291

(22) Filed: Apr. 21, 2021

Related U.S. Application Data
(63) Continuation-in-part of application No. 17/209,038, filed on Mar. 22, 2021.
Application No. 17/209,038 is a continuation-in-part of application No. 16/942,229, filed on Jul. 29, 2020.
Application No. 16/942,229 is a continuation-in-part of application No. 16/785,020, filed on Feb. 7, 2020.
Application No. 16/785,020 is a continuation-in-part of application No. 16/785,076, filed on Feb. 7, 2020.
(60) Provisional application No. 62/942,103, filed on Nov. 30, 2019.
(60) Provisional application No. 62/926,225, filed on Oct. 25, 2019.
(60) Provisional application No. 63/018,930, filed on May 1, 2020.
(60) Provisional application No. 63/019,145, filed on May 1, 2020.

(51) Int. Cl. H01M 10/0569; H01M 10/0525; H01M 4/133; H01M 4/587

(52) U.S. Cl. CPC H01M 10/0569; H01M 10/0525; H01M 2004/027; H01M 4/587; H01M 2300/004; H01M 4/133

(57) ABSTRACT

Batteries including an electrolyte with a ternary solvent package are disclosed. In various implementations, a lithium-sulfur battery may include a cathode, an anode, and an electrolyte include a ternary solvent package. The anode may be positioned opposite to the cathode. The cathode may include a plurality of regions. Each region may be defined by two or more core-shell structures adjacent to and in contact with each other. The electrolyte may be interspersed throughout the cathode and be in contact with the anode. The ternary solvent package may include 1,2-Dimethoxyethane (DME), 1,3-Dioxolane (DOL), tetraethylene glycol dimethyl ether (TEGDME), and/or one or more additives, such as lithium nitrate (LiNO₃), and 4,4′-thiobisbenzenethiol (TBT) or 2-mercaptobenzothiazole (MBT), and approximately 0.01 mol of dissolved lithium bis(trifluoromethanesulfonyl)imide (LiTFSI).

### CROSS-REFERENCE TO RELATED APPLICATIONS

This Patent Application is a continuation-in-part application and claims priority to U.S. patent application Ser. No. 17/209,038 entitled “CARBON COMPOSITE ANODE WITH EX-SITU ELECTRODEPOSITED LITHIUM” filed on Mar. 22, 2021, which is a continuation-in-part application and claims priority to U.S. patent application Ser. No. 16/942,229 entitled “CARBON-BASED STRUCTURES FOR INCORPORATION INTO LITHIUM (LI) ION BATTERY ELECTRODES filed on Jul. 29, 2020, which is a continuation-in-part application of and claims priority to U.S. patent application Ser. No. 16/785,020 entitled “3D SELF-ASSEMBLED MULTI-MODAL CARBON BASED PARTICLE” filed on Feb. 7, 2020 and to U.S. patent application Ser. No. 16/785,076 entitled “3D SELF-ASSEMBLED MULTI-MODAL CARBON BASED PARTICLES INTEGRATED INTO A CONTINUOUS FILM LAYER” filed on Feb. 7, 2020, both of which claim priority to U.S. Provisional Patent Application No. 62/942,103 entitled “3D HIERARCHICAL MESOPOROUS CARBON-BASED PARTICLES INTEGRATED INTO A CONTINUOUS ELECTRODE FILM LAYER” filed on Nov. 30, 2019 and to U.S. Provisional Patent Application No. 62/926,225 entitled “3D HIERARCHICAL MESOPOROUS CARBON-BASED PARTICLES INTEGRATED INTO A CONTINUOUS ELECTRODE FILM LAYER” filed on Oct. 25, 2019, and this Patent application claims the benefit of priority to U.S. Provisional Patent Application No. 63/019,145, entitled “RUBBER VULCANIZATION ACCELERATORS AS ELECTROLYTE ADDITIVES” filed on May 1, 2020, and to U.S. Provisional Patent Application No. 63/018,930, entitled “PREVENTING POLYSULFIDE MIGRATION” filed on May 1, 2020, all of which are assigned to the assignee hereof. The disclosures of all prior Applications are considered part of and are incorporated by reference in this Patent Application in their respective entireties.

### TECHNICAL FIELD

This disclosure relates generally to batteries, and, more particularly, to lithium-ion batteries that can compensate for operational cycle losses.

### DESCRIPTION OF RELATED ART

Recent developments in batteries allow consumers to use electronic devices in many new applications. However, further improvements in battery technology are desirable.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure may be implemented as a lithium-sulfur electrochemical cell including a cathode and an anode positioned opposite to the cathode. The cathode may include various regions, where each region may be defined by two or more core-shell structures adjacent to and in contact with each other. The lithium-sulfur electrochemical cell may include an electrolyte with a ternary solvent package. In one implementation, the electrolyte may include the ternary solvent package and 4,4′-thiobisbenzenethiol (TBT). Alternatively, in another implementation, the electrolyte may include the ternary solvent package and 2-mercaptobenzothiazole (MBT). The electrolyte may be interspersed throughout the cathode and in contact with the anode.

In one implementation, the ternary solvent package may include 1,2-Dimethoxyethane (DME), 1,3-Dioxolane (DOL), tetraethylene glycol dimethyl ether (TEGDME), and or one or more additives, which may include lithium nitrate (LiNO₃). For example, in one implementation, the ternary solvent package may be prepared with 5,800 microliters (μL) of DME, 2,900 microliters (μL) of DOL, and 1,300 microliters (μL) of TEGDME and include approximately 0.01 mol of dissolved lithium bis(trifluoromethanesulfonyl)imide (LiTFSI). The ternary solvent package may be prepared at a first approximate dilution level of 1 molar (M) LiTFSI in a mixture of DME:DOL:TEGDME. The ternary solvent package may be prepared at a second approximate dilution level of approximately 1 M LiTFSI in DME:DOL:TEGDME at a volume ratio of volume:volume:volume=58:29:13 including 2 weight percent (wt. %) lithium nitrate.

Alternatively, in another implementation, the ternary solvent package may be prepared with 2,000 microliters (μL) of DME, 8,000 microliters (μL) of DOL, and 2,000 microliters (μL) of TEGDME and include approximately 0.01 mol of dissolved lithium bis(trifluoromethanesulfonyl)imide (LiTFSI). The ternary solvent package may be prepared at a first approximate dilution level of 1 molar (M) LiTFSI in a mixture of DME:DOL:TEGDME. The ternary solvent package may be prepared at a second approximate dilution level of approximately 1 M LiTFSI in DME:DOL:TEGDME at an approximate volume ratio of volume:volume:volume=1:4:1 and include either an addition of 5M TBT solution or an addition of 5M MBT solution.

In various implementations, each core-shell structure may be a carbon nano-onion (CNO), which may include a relatively high-density outer shell region and a relatively low-density core region. In some aspects, the core region may be positioned within an interior region of the outer shell region. The outer shell region may have a first carbon density, such as between approximately 2.0 grams per cubic centimeter (g/cc) and 2.3 g/cc. The core region may have a second carbon density that is lower than the first carbon density. For example, the second carbon density may be between approximately 0.0 g/cc and 2.0 g/cc.

The regions of the cathode may include microporous channels, mesoporous channels, and macroporous channels. In one implementation, at least some of the microporous channels, the mesoporous channels, and the macroporous channels may connect with each other and form a porous network that may extend from the outer shell region to the core region. For example, the porous network may include pores that each have a principal dimension of approximately 1.5 nm.

In various implementations, the regions of the cathode may temporarily microconfine an elemental sulfur. In some aspects, the ternary solvent package may have a tunable polarity, a tunable solubility, and include ions. For example, the ternary solvent package, in some aspects, may provide a soluble medium through which lithium ions may flow during battery cycling. Similarly, the ternary solvent package may at least temporarily suspend polysulfides (PS) during charge-discharge cycles of the lithium-sulfur electrochemical cell.

The anode of the lithium-sulfur electrochemical cell may, in some aspects, be a graphitic scaffold, which may include graphene sheets stacked vertically. In one implementation, at least some adjacent graphene sheets may intercalate lithium ions, which may chemically react with carbon provided by exposed surfaces of the corresponding graphene sheets. Lithium, provided by the lithium ions, and carbon provided by the adjacent graphene sheets, may chemically react with each other to produce lithiated or lithium-intercalated graphite (LiC₆). As a result, in this implementation, the graphitic scaffold may at least partially convert to lithium-intercalated graphite.

In various implementations, the regions of the cathode may include, such as by pre-loading prior to battery cycling, elemental sulfur. The elemental sulfur may chemically react with available lithium in the electrolyte, during battery cycling, to generate poly sulfides, which may be suspended within the electrolyte and confined to the regions. The cathode, which may include flexure points that encompass several of the regions, may volumetrically expand to accommodate these trapped polysulfides while continuing to permit lithium ions in the electrolyte flow freely, resulting in improved performance and cyclability of the lithium-sulfur electrochemical cell.

In some implementations, a separator may be positioned between the cathode and the anode. For example, in one implementation, the separator may be coated with one or more of a ceramic-containing compound or an aluminum fluoride containing mixture. In some aspects, the separator may be porous to allow lithium ions to flow through the separator. As a result, the lithium ions may flow from or to the anode and/or the cathode depending on charge or discharge cycling operations of the lithium-sulfur electrochemical cell. In addition, an artificial solid-electrolyte interphase may be formed on the anode in response to battery cycling of the lithium-sulfur electrochemical cell. In some aspects, a barrier layer including a mechanical strength enhancer may be coated on the anode.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic diagram depicting an example battery, according to some implementations.

FIG. 2 is a schematic diagram depicting another example battery, according to some implementations.

FIG. 3 is a diagram showing an example electrode of the battery of FIG. 1, according to some implementations.

FIG. 4 is a diagram showing a single layer of graphene that can be used in the battery of FIG. 1, according to some implementations.

FIG. 5 is a schematic diagram showing a graphene nanoplatelet including several layers of the graphene of FIG. 2, according to some implementations.

FIG. 6 is a schematic diagram showing several graphene nanoplatelets joined together to form an aggregate, according to some implementations.

FIG. 7 is a micrograph showing multiple layers of the graphene-containing materials of FIGS. 4 to 6, according to some implementations.

FIG. 8 is a micrograph of a carbon-based growth decorated with cobalt that can be used in the battery of FIG. 1, according to some implementations.

FIGS. 9 and 10 are micrographs of various carbon nano-onion (CNO) aggregates, according to some implementations.

FIG. 11 shows a table of example electrolyte chemical substances of the battery of FIG. 1, according to some implementations.

FIG. 12 shows a bar chart depicting performance of various materials, according to some implementations.

FIG. 13 show graphs depicting performance per cycle number, according to some implementations.

FIG. 14 shows a bar chart depicting capacity per cycle number, according to some implementations.

FIG. 15 show graphs depicting performance per cycle number, according to some implementations.

FIG. 16 shows a graph depicting discharge capacity per cycle number, according to some implementations.

FIG. 17 shows a graph depicting discharge capacity per cycle number, according to some implementations.

FIG. 18 shows an example process for preparing a ternary solvent package with one or more additive, according to some implementations.

FIG. 19 is a schematic diagram showing the chemical structure of TBT, according to some implementations.

FIG. 20 shows a graph depicting specific discharge capacity for various TBT-containing electrolyte mixtures, according to some implementations.

FIG. 21 show graphs depicting specific discharge capacity per cycle number, according to some implementations.

FIG. 22 shows a bar chart depicting specific discharge capacity improvement with 5M TBT containing electrolyte per cycle number, according to some implementations.

FIG. 23 shows an example process for preparing a ternary solvent package including TBT or MBT with one or more additive, according to some implementations.

FIG. 24 is a schematic diagram depicting an example chemical reaction between MBT with a sulfur (S²⁻) ion, according to some implementations.

FIG. 25 shows various sulfur vulcanization accelerators and their corresponding chemical structures, according to some implementations.

FIG. 26 is a schematic diagram depicting an example chemical reaction mechanism between MBT and styrene, according to some implementations.

FIG. 27 is a schematic diagram depicting an example chemical reaction mechanism between MBT and divinyl benzene, according to some implementations.

FIG. 28 is a schematic diagram depicting an example chemical reaction mechanism for the complexation of a zinc (Zn²⁺) ion with 2,2′-Dithiobis(benzothiazole) MBTS, according to some implementations.

FIG. 29 is a schematic diagram depicting an example chemical reaction mechanism for the formation of zinc stearate, according to some implementations.

FIG. 30 is a schematic diagram depicting carbon porosity types, according to some implementations.

FIG. 31 is a graph depicting pore size compared against distribution, according to some implementations.

FIG. 32 shows a volume histogram for pore volume compared against pore width for the cathodes of the battery of either FIG. 1 or FIG. 2, according to some implementations.

FIG. 33 shows an area histogram for surface area compared against pore width for the cathodes of the battery of either FIG. 1 or FIG. 2, according to some implementations.

FIG. 34 shows another volume histogram for pore volume compared against pore width for the cathodes of the battery of either FIG. 1 or FIG. 2, according to some implementations.

FIG. 35 shows another area histogram for surface area compared against pore width for the cathodes of the battery of either FIG. 1 or FIG. 2, according to some implementations.

FIG. 36 shows graphs depicting performance of lithium-sulfur batteries with coated components, according to some implementations.

Like reference numbers and designations in the various drawings indicate like elements.

### DETAILED DESCRIPTION

The following description is directed to some example implementations for the purposes of describing innovative aspects of this disclosure. However, a person having ordinary skill in the art will readily recognize that the teachings herein can be applied in a multitude of different ways. The described implementations can be implemented in any type of electrochemical cell, battery, or battery pack, and can be used to compensate for electrolyte performance deficiencies. As such, the disclosed implementations are not to be limited by the examples provided herein, but rather encompass all implementations contemplated by the attached claims. Additionally, well-known elements of the disclosure will not be described in detail or will be omitted so as not to obscure the relevant details of the disclosure.

Batteries typically include several electrochemical cells, which can be connected to each other to provide electric power to a wide variety of devices such as (but not limited to) mobile phones, laptops, electric vehicles (EVs), factories, and buildings. Certain types of batteries, such as lithium-ion or lithium-sulfur batteries, may be limited in performance by the type of electrolyte used. Optimization of the electrolyte may improve the cyclability, the rate capability, the safety, and the lifespan of a respective battery. For example, electrolytes may be tuned to meet certain battery usage requirements. In a new or “fresh” battery, lithium ions flow freely from the anode to the cathode during a discharge cycle. During a battery charge cycle, lithium ions are forced to migrate back from their electrochemically favored positions in the cathode to the anode, where they can be stored for subsequent use. Lithium-containing polysulfide intermediates are generated upon interaction of lithium ions with sulfur pre-loaded in the cathode for lithium-sulfur batteries during battery charge-discharge cycling. These intermediates are soluble in the electrolyte and therefore diffuse throughout the cell during battery cycling, impeding the free travel of lithium ions as required for optimal battery performance. Excessive generation of polysulfide intermediates can result in capacity decay and cell failure during battery cycling.

Lithium polysulfide intermediates participate in the formation of inorganic layers in a solid electrolyte interphase (SEI), which may form on the anode. The anode may be protected by a stable inorganic layer formed in the electrolyte containing 0.020 M Li₂S₅ (0.10 M sulfur) and 5.0 wt % LiNO₃. The anode with a lithium fluoride and lithium polysulfide intermediates (LiF—Li₂Sₓ) may enrich the SEI and result in a stable Coulombic efficiency of 95% after 233 cycles for Li—Cu half cells, while preventing formation of lithium dendrites. However, when lithium-containing polysulfide intermediates (also referred to as “polysulfides”) are generated (such as during demanding discharge or charge cycling rates and/or extended usage over many cycles) at certain concentrations (such as greater than 0.50 M sulfur), formation of the SEI may be hindered. As a result, lithium metal from the anode may be etched. This type of unwanted deterioration (etching) of the anode due to a relatively high concentration of polysulfide intermediates indicates that polysulfide dissolution and diffusion may need to be regulated to optimize battery performance.

The cathode porosity may be controlled or adjusted to optimize lithium-sulfur battery energy density. While relatively high sulfur areal pre-loading has been pursued, less attention has been paid to cathode porosity. For example, cathode porosity may be higher in sulfur and carbon composite cathodes compared to traditional lithium-ion battery electrodes. Denser electrodes with relatively low porosity may minimize electrolyte intake, parasitic weight, and cost. Sulfur utilization may be limited by the solubility of polysulfide intermediates and conversion from those intermediates to lithium disulfide (Li₂S). The conversion of polysulfide intermediates may be based on the accessible surface area of the porous carbon cathode. As a result, cathode porosity may also be optimized in view of electrolyte constituent material selection to maximize battery volumetric energy density.

Various aspects of the subject matter disclosed herein relate to a lithium-sulfur battery including an electrolyte, which may include a ternary solvent package and one or more additives. In accordance with various implementations of the subject matter disclosed herein, the lithium-sulfur battery may include a cathode, an anode positioned opposite to the cathode, and the electrolyte. The cathode may include several regions, where each region may be defined by two or more core-shell structures adjacent to and in contact with each other. In some instances, the electrolyte may include the ternary solvent package, be interspersed throughout the cathode and be in contact with the anode. In one implementation, the electrolyte may include the ternary solvent package and 4,4′-thiobisbenzenethiol (TBT). In another implementation, the electrolyte may include the ternary solvent package and 2-mercaptobenzothiazole (MBT).

In some aspects, the ternary solvent package may include 1,2-Dimethoxyethane (DME), 1,3-Dioxolane (DOL), tetraethylene glycol dimethyl ether (TEGDME), and one or more additives, which may include a lithium nitrate (LiNO₃), all which may be in a liquid-phase. In one implementation, the ternary solvent package may be prepared by mixing together approximately 5,800 microliters (μL) of DME, 2,900 microliters (μL) of DOL, and 1,300 microliters (μL) of TEGDME to create a mixture. Approximately 0.01 mol of lithium bis(trifluoromethanesulfonyl)imide (LiTFSI) may be dissolved into ternary solvent package to produce an approximate dilution level of 1 M LiTFSI in DME:DOL:TEGDME at a volume ratio of volume:volume:volume=58:29:13 including approximately 2 weight percent (wt. %) lithium nitrate.

Alternatively, in another implementation, the ternary solvent package may be prepared with 2,000 microliters (μL) of DME, 8,000 microliters (μL) of DOL, and 2,000 microliters (μL) of TEGDME and include approximately 0.01 mol of dissolved lithium bis(trifluoromethanesulfonyl)imide (LiTFSI). The ternary solvent package may be prepared at a first approximate dilution level of 1 molar (M) LiTFSI in a mixture of DME:DOL:TEGDME. The ternary solvent package may be prepared at a second approximate dilution level of approximately 1 M LiTFSI in DME:DOL:TEGDME at an approximate volume ratio of volume:volume:volume=1:4:1 and include either an addition of 5M TBT solution or an addition of 5M MBT solution, or an addition of other additives and/or chemical substances.

In various implementations, each core-shell structure may be a carbon nano-onion (CNO), which may include a relatively high-density outer shell region and a relatively low-density core region. In some aspects, the core region may be positioned within an interior region of the outer shell region. The outer shell region may have a first carbon density, such as between approximately 1.0 grams per cubic centimeter (g/cc) and 2.3 g/cc. The core region may have a second carbon density that is lower than the first carbon density. For example, the second carbon density may be between approximately 0.0 g/cc and 1.0 g/cc.

The regions of the cathode may include microporous channels, mesoporous channels, and macroporous channels. In one implementation, at least some of the microporous channels, the mesoporous channels, and the macroporous channels may connect with each other and form a porous network that may extend from the outer shell region to the core region. For example, the porous network may include pores that each have a principal dimension of approximately 1.5 nm.

In various implementations, the regions of the cathode may temporarily microconfine an elemental sulfur. In some aspects, the ternary solvent package may have a tunable polarity, a tunable solubility, and include lithium ions. For example, the ternary solvent package, in some aspects, may provide a soluble medium through which lithium ions may flow during battery cycling. Similarly, the ternary solvent package may at least temporarily suspend polysulfides (PS) during charge-discharge cycles of the lithium-sulfur electrochemical cell.

Particular implementations of the subject matter described in this disclosure can be implemented to realize one or more potential advantages. In some implementations, the porous network formed by connection of some of the micro-, meso-, and macroporous channels of the cathode may include several pore types including a first, second, and third pore type. The first pore type may be microporous, such as having a pore size of approximately less than 5 nm. The second pore type may be mesoporous, such as having a pore size between approximately 5 to 50 nm. The third pore type may be macroporous, such as having a pore size greater than approximately 50 nm. In some implementations, the three pore types may work independently or in unison to mitigate unwanted shuttle of polysulfide intermediates within the electrolyte. Since polysulfide shuttle interferes with transport of lithium ions in the electrolyte, control, and reduction of such unwanted shuttle, such as by the three pore types, results in noticeable battery performance improvement (e.g., measured in energy storage capacity and/or power delivery).

In some instances, a first type of pore may have a pore size of approximately 1.5 nm, for example, to microconfine elemental sulfur (S₈) pre-loaded into the cathode. TBT or MBT, when complexing with sulfur ions generated during battery cycling, may partially block movement of long-chain polysulfide containing intermediates within, for example, the second pore type pores. As a result, cathodes including the first, second and third pore types may volumetrically expand to retain the intermediates and thereby minimize the polysulfide shuttle effect. Accordingly, lithium ions may continue to flow freely (such as through a “cascade” effect and/or due to differences in electrochemical potential between the anode and the cathode) in the electrolyte without being blocked or impeded by the polysulfide intermediates. The free flow of lithium ions throughout the electrolyte (such as without interference by the polysulfides) can increase battery performance. As further described below, specific combinations of pore sizes created by, for example, adjacent core-shell structures, matched with unique electrolyte formulations can reduce or mitigate the harmful effects of unwanted polysulfide diffusion even further to produce even greater battery performance improvements.

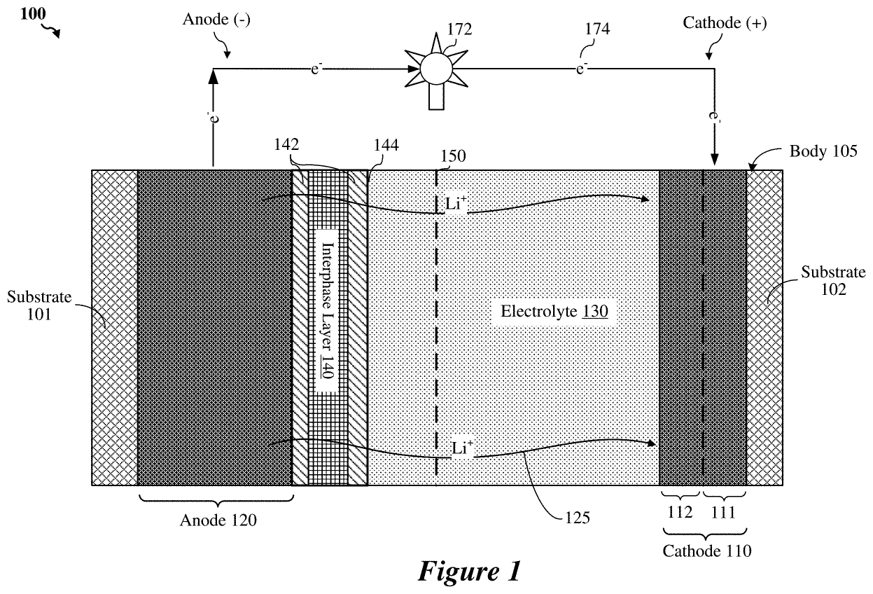

FIG. 1 shows an example battery 100, according to some implementations. The battery 100 may be a lithium-sulfur electrochemical cell, a lithium-ion battery, or a lithium-sulfur battery. The battery 100 may have a body 105 that may include a cathode 110, an anode 120, a first substrate 101, a second substrate 102, and an electrolyte 130. In some aspects, the first substrate 101 may function as a current collector for the anode 120, and the second substrate 102 may function as a current collector for the cathode 110. In some aspects, the anode 120 may be positioned opposite to the cathode 110. The cathode 110 may include a first thin film 111 deposited onto the second substrate 102 and may include a second thin film 122 deposited onto the first thin film 121. In some implementations, the electrolyte may be 130 be a liquid-phase electrolyte including one or more additives such as lithium nitrate, tin fluoride, lithium iodide, lithium bis(oxalate)borate (LiBOB), and/or the like. Suitable solvent packages for these example additives may include various dilution ratios, including 1:1:1, of 1,3-dioxolane (DOL), 1,2-dimethoxyethane, (DME), tetraethylene glycol dimethyl ether (TEGDME), and/or the like.

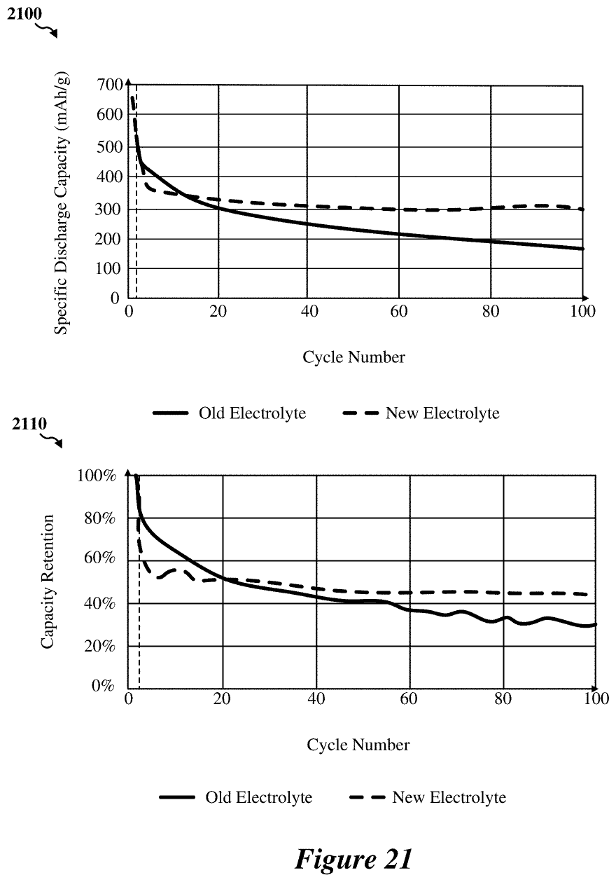

Although not shown for simplicity, in one implementation, a lithium layer may be electrodeposited on one or more exposed carbon surfaces of the anode 120. In some instances, the lithium layer may include elemental lithium provided by the ex-situ lithium electrodeposition onto exposed surfaces of the anode 120. In addition, or in the alternative, the lithium layer may include lithium, calcium potassium, magnesium, sodium, and/or cesium, where each metal may be ex-situ deposited onto exposed carbon surfaces of the anode 120. The lithium layer may provide lithium ions available for transport to-and-from the cathode 110 during operational cycling of the battery 100. As a result, in this implementation, no additional lithium source is required in the cathode 110, such as lithium disulfide (LiS₂), a common electroactive material that may be used in other lithium-sulfur electrochemical cell and/or battery configurations. Instead of using lithium disulfide, elemental sulfur (S₈) may be pre-loaded (e.g., referring to shipment of the battery 100 prior to activation of the battery 100) in pores (such as those shown in FIG. 3000) of the cathode 110. The elemental sulfur may form lithium-sulfur complexes during lithium-sulfur battery cycling to temporarily microconfine and/or retain higher quantities of lithium compared to, for example, non-sulfur inclusive lithium-ion chemistries alone. As a result, the battery 100 may consistently outperform non-sulfur inclusive lithium-ion chemistries (such as shown by FIG. 21 and elsewhere in the present disclosure) and provide power to more demanding application areas, such as in electric vehicles (EVs).

In some implementations, the battery 100 may include a solid-electrolyte interphase layer 140. The solid-electrolyte interphase layer 140 may, in some instances, be formed artificially on the anode 120 during battery cycling of the battery 100. In such instances, the solid-electrolyte interphase layer 140 may also be referred to as an artificial solid-electrolyte interphase, or A-SEI. The solid-electrolyte interphase layer 160, when formed as an A-SEI, may include tin, manganese, molybdenum, and/or fluorine compounds. The molybdenum may provide cations, and the fluorine compounds may provide anions. The cations and anions may produce salts such as tin fluoride, manganese fluoride, silicon nitride, lithium nitride, lithium nitrate, lithium phosphate, manganese oxide, lithium lanthanum zirconium oxide (LLZO, Li₇La₃Zr₂O₁₂), etc. In some instances, the A-SEI may be formed in response to exposure of lithium ions 125 to the electrolyte 130, which may include solvent-based solutions including tin and/or fluorine.

In various implementations, the solid-electrolyte interphase layer 140 may be artificially provided on the anode 120 prior to activation of the battery 100. Alternatively, in one implementation, the solid-electrolyte interphase layer 140 may form naturally, e.g., during operational cycling of the battery 100, on the anode 120. In some instances, the solid-electrolyte interphase layer 140 may provide a passivation layer including an outer layer of shielding material that can be applied to the anode 120 as a micro-coating. In this way, formation of the solid-electrolyte interphase layer 140 on the anode 120 facing the electrolyte 130 may reduce decomposition of the electrolyte 130.

In some implementations, the battery 100 may include a barrier layer 142. The barrier layer 142 may include a mechanical strength enhancer 144 coated and/or deposited on the anode 120. In some aspects, the mechanical strength enhancer 144 may provide structural support for the battery 100, may prevent lithium dendrite formation from the anode 120, and/or may prevent dispersion of lithium dendrite throughout the battery 100. In some implementations, the mechanical strength enhancer 144 may be formed as a protective coating over the anode 120, and may include one or more carbon allotropes, carbon nano-onions (CNOs), nanotubes (CNTs), reduced graphene oxide, graphene oxide (GO), and/or carbon nano-diamonds. In some instances, the solid-electrolyte interphase layer 140 may be formed within the mechanical strength enhancer 144.

In implementations for which the lithium layer includes elemental lithium, the elemental lithium may dissociate and/or separate into lithium ions 125 and electrons 174 during a discharge cycle of the battery 100. The lithium ions 125 (such as provided by the lithium layer, not shown for simplicity) may move from the anode 120 towards the cathode 110 through the electrolyte 130 to their electrochemically favored positions within the cathode 110, as shown in the example of FIG. 1. As the lithium ions 125 move through the electrolyte 130, the electrons 174 are released from the elemental lithium (e.g., at least partly provided by the lithium layer). As a result, the electrons 174 may travel from the anode 120 to the cathode 110 through, for example, a circuit to power a load 172. The load 172 may be any suitable circuit, device, or system such as (but not limited to) a lightbulb, consumer electronics, or an electric vehicle (EV).

In some implementations, each of the first substrate 101 and the second substrate 102 may be a current collector, such as a solid aluminum or copper metal foil. In some instances, the first and second substrates 101 and 102 may be a solid copper metal foil. The first and second substrates 101 and 102 may influence the energy capacity, rate capability, lifespan, and long-term stability of the battery 100. The first and second substrates 101 and 102 may be subject to etching, carbon coating, or other suitable treatment to increase electrochemical stability and/or electrical conductivity of the battery 100.

In other implementations, the first substrate 101 and/or the second substrate 102 may include or may be formed from aluminum, copper, nickel, titanium, stainless steel and/or carbonaceous materials (such as depending on end-use applications and/or performance requirements of the battery 100). For example, the first substrate 101 and/or the second substrate 102 may be individually tuned or tailored such that the battery meets one or more performance requirements or metrics.

In some aspects, the first substrate 101 and/or the second substrate 102 may be at least partially foam-based or foam-derived and can be selected from any one or more of metal foam, metal web, metal screen, perforated metal, or a sheet-based 3D structure. In other aspects, the first substrate 101 and/or the second substrate 102 may be a metal fiber mat, metal nanowire mat, conductive polymer nanofiber mat, conductive polymer foam, conductive polymer-coated fiber foam, carbon foam, graphite foam, or carbon aerogel. In some other aspects, the first substrate 101 and/or second substrate 102 may be carbon xerogel, graphene foam, graphene oxide foam, reduced graphene oxide foam, carbon fiber foam, graphite fiber foam, exfoliated graphite foam, or combinations thereof.

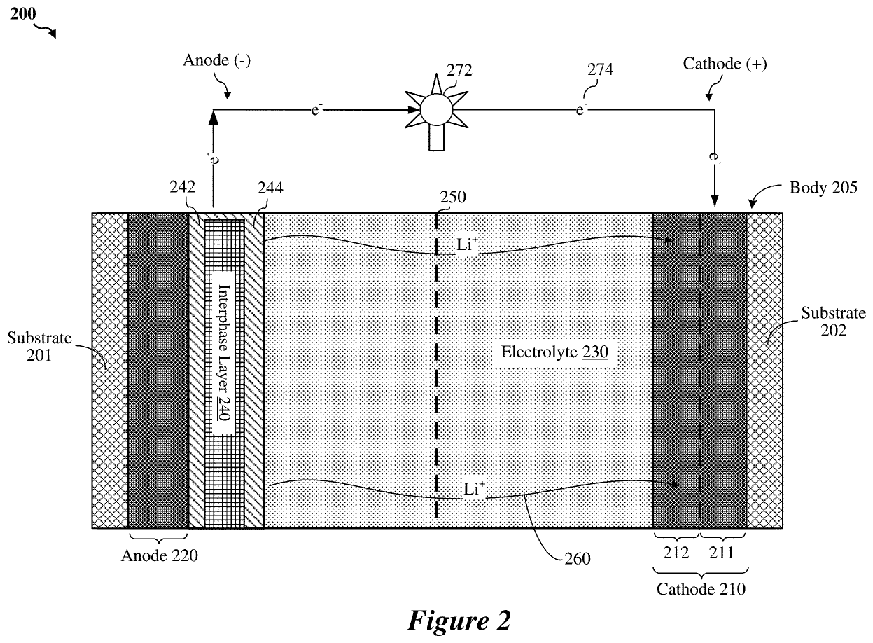

FIG. 2 shows another example battery 200, according to some implementations. The battery 200 may be similar to the battery 100 of FIG. 1 in many respects, such that description of like elements is not repeated herein. In some implementations, the battery 200 may be a next-generation battery, such as a lithium-metal battery and/or a solid-state battery, instead of incorporating lithium-ion and/or lithium-sulfur chemistries. Accordingly, an electrolyte 230 contained within a body 205 of the battery 200 may be solid or substantially solid. For example, in some instances, the electrolyte 230 may begin in a gel phase and then later solidify upon activation of the battery 200. The battery 200 may alleviate energy storage concerns resulting from sulfur loss and poly sulfides by replacing carbon scaffolded anodes with a single solid metal layer of lithium. For example, the anode 120 of the battery 100 of FIG. 1 may include carbon scaffolds, while the anode 220 of the battery 200 of FIG. 2, also referred to as a “lithium-metal anode,” may be a lithium-metal anode devoid of any carbon material. In one implementation, the lithium-metal anode may be formed as a single solid lithium metal layer and referred to as a “lithium metal anode.”

Energy density gains associated with various cathode materials may be based on whether lithium metal is used in the anode 220. For example, high-capacity cathodes may need thicker or denser anodes in order to supply the increased quantities of lithium consumed by the high-capacity cathodes. Anodes hosted by structures such as the host structure 138 of FIG. 1 may provide a structure capable of retaining greater amounts of lithium within the anode. For example, six carbon atoms may be necessary to hold a single lithium atom for carbonaceous materials. By using a pure lithium metal anode, such as the anode 220, batteries disclosed herein may reduce or even eliminate carbon use in the anode 220 which, turn, may store in a relatively smaller volume. In this way, the energy density of the battery 200 may be greater than conventional batteries of, for example, a similar size. Lithium metal anodes, such as the anode 220, may not function with liquid-phase electrolyte materials, and therefore may benefit from a solid-state electrolyte capable of limiting lithium dendrite formation and growth. Also, a solid-state specific separator (such as a separator 250) may further limit dendrite formation and growth. The separator 250 may have a similar ionic conductivity as the liquid-phase electrolyte yet reduce lithium dendrite formation. Moreover, the separator 250 may be formed from a ceramic containing material and may, as a result, fail to chemically react with metallic lithium. As a result, the separator 250 may be used to control lithium ion transport, e.g., such as through pores or openings within the separator 250, while concurrently preventing flow or passage of electrons through the electrolyte 230, thereby preventing a short-circuit through the battery 200.

In one implementation, a void space intended to replace the anode 220 may be formed within the battery 200. Operational cycling of the battery 200 in this implementation may result in the deposition of lithium, such as provided by lithium disulfide pre-loaded onto exposed carbon surfaces of the cathode 210 and/or lithium ions 260 prevalent in the electrolyte 230, into the void spade. As a result, the void space may transform into a lithium-containing region (such as a solid lithium metal layer) and function as the anode 220. In some aspects, the void space may be created in response to chemical reactions between a metal-containing electrically inactive component and a graphene-containing component. Specifically, the graphene-containing component may chemically react with lithium deposited into the void space during operational cycling and produce lithiated graphite (LiC₆) or a patterned lithium metal. The lithiated graphite produced by the chemical reactions may generate or lead to the generation and/or liberation of lithium ions and/or electrons that can be used to carry electric charge or a “current” between the anode 120 and the cathode 110 during discharge cycles of the battery 200. And, where the anode 220 is a solid lithium metal layer, the battery 200 may be able to hold more electroactive material and/or lithium per unit volume. That is, compared to batteries with scaffolded carbon and/or intercalated lithiated graphite anodes, the anode 220, when prepared as a solid lithium metal layer, may result in the battery 200 having a higher energy density and/or specific capacity, resulting in longer discharge cycle times and additional power output per unit time.

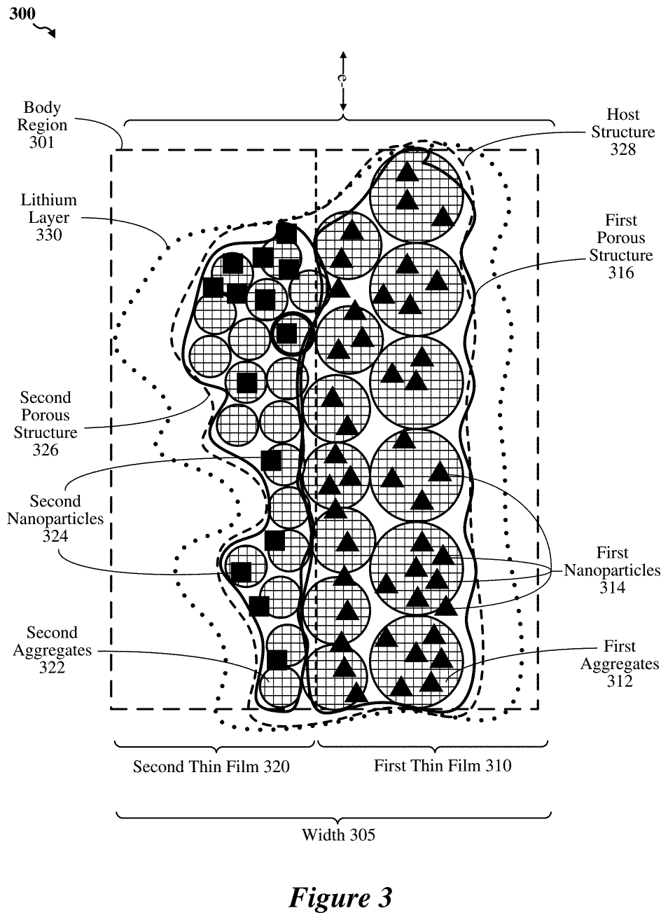

FIG. 3 shows an example electrode 300. In some implementations, the electrode 300 may be implemented as either a positive electrode (cathode) or a negative electrode (anode) of the battery 100 of FIG. 1. In some other implementations, the electrode 300 may be implemented as the cathode 210 of the battery 200 of FIG. 2. When the electrode 300 is implemented as a cathode (such as the cathode 110 of the battery 100 of FIG. 1), the electrode 300 may temporarily microconfine an electroactive material, such as elemental sulfur. In some implementations, the electrode 300 may provide an excess supply of lithium and/or lithium ions suitable to compensate for first-cycle operational losses as may be encountered in lithium-ion and/or lithium-sulfur batteries, such as the battery 100 of FIG. 1.

In some aspects, the electrode 300 may be porous and receptive of a liquid-phase electrolyte, such as the electrolyte 130 of FIG. 1. Electroactive species, such as lithium ions 125 suspended in the electrolyte 130, may chemically react with elemental sulfur pre-loaded into pores of the electrode 300 to produce polysulfides, which may be trapped in the electrode 300 during battery cycling. In some aspects, the electrode 300 may expand along flexure points to retain additional quantities of polysulfides created during battery cycling. As a result, the lithium ions 125 may flow freely through the electrolyte from the anode 120 to the cathode 110 during discharge cycles of the battery without being impeded by polysulfides typically produced when lithium reacts with sulfur. For example, when lithium ions 125 reach the cathode 110 and react with elemental sulfur contained in or associated with the cathode 110, sulfur is reduced to lithium polysulfides (Li₂Sₓ) at decreasing chain length according to the order Li₂S₈→Li₂S₆→Li₂S₄→Li₂S₂→Li₂S, where 2≤x≤8). Higher order polysulfides may be soluble in various types of solvent and/or electrolyte, thereby interfering with lithium ion transport necessary for healthy battery operation. Retention of those higher order polysulfides by the electrode 300 thereby allows lithium ions to flow more freely in the electrolyte.

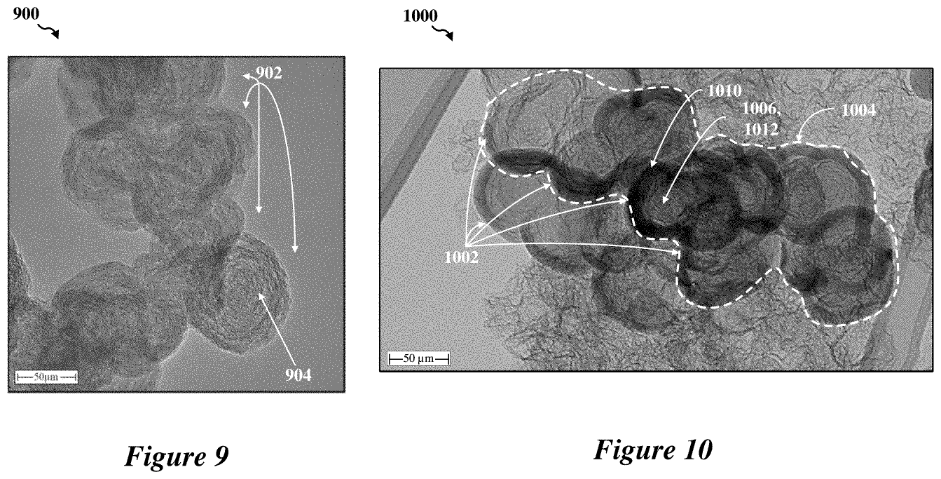

The electrode 300 may include a body region 301 defined by a width 305 and may include a first thin film 310 and a second thin film 320. The first film 310 may include a plurality of first aggregates 312 that join together to form the first porous structure 316 of the electrode 300. In some instances, the first porous structure 316 may have an electrical conductivity between approximately 0 and 500 S/m. In other instances, the first electrical conductivity may be between approximately 500 and 1,000 S/m. In some other instances, the first electrical conductivity may be greater than 1,000 S/m. In some aspects, the first aggregates 312 may include carbon nano-tubes (CNTs), carbon nano-onions (CNOs, such as those shown in FIG. 9 and FIG. 10), flaky graphene, crinkled graphene, graphene grown on carbonaceous materials, and/or graphene grown on graphene.

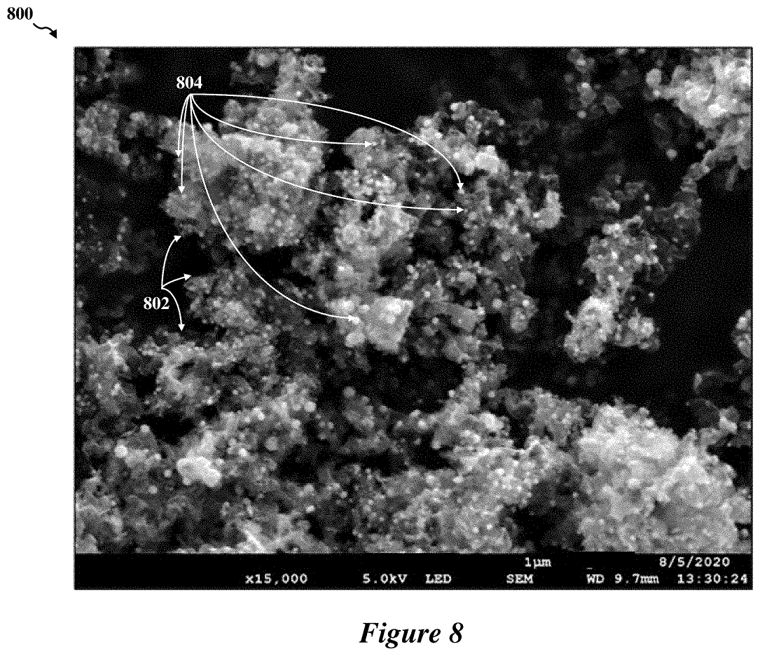

In some implementations, the first aggregates 312 may be decorated with a plurality of first nanoparticles 314. In some instances, the first nanoparticles 314 may include tin, lithium alloy, iron, silver, cobalt, semiconducting materials and/or metals such as silicon and/or the like. In some aspects, CNTs, due to their ability to provide high exposed surface areas per unit volume and stability at relatively high temperatures (such as above 77° F. or 25° C.), may be used as a support material for the first nanoparticles 314. For example, the first nanoparticles 314 may be immobilized (such as by decoration, deposition, surface modification or the like) onto exposed surfaces of CNTs and/or other carbonaceous materials. The first nanoparticles 314 may react with chemically available carbon on exposed surfaces of the CNTs and/or other carbonaceous materials, for example, as shown by the cobalt-decorated carbon-growths shown in FIG. 8.

The second thin film 320 may include a plurality of second aggregates 322 that join together to form a second porous structure 326. In some instances, the electrical conductivities of the first and second porous structures 316 and/or 326 may be between approximately 0 S/m and 250 S/m. In instances for which the first porous structure 316 includes a higher concentration of aggregates than the second porous structure 326, the first porous structure 316 may have a higher electrical conductivity than the second porous structure 326. In one implementation, the first electrical conductivity may be between approximately 250 S/m and 500 S/m, while the second electrical conductivity may be between approximately 100 S/m and 250 S/m. In another implementation, the second electrical conductivity may be between approximately 250 S/m and 500 S/m. In yet another implementation, the second electrical conductivity may be greater than 500 S/m. In some aspects, the second aggregates 322 may include CNTs, CNOs, flaky graphene, crinkled graphene, graphene grown on carbonaceous materials, and/or graphene grown on graphene.

The second aggregates 322 may be decorated with a plurality of second nanoparticles 324. In some implementations, the second nanoparticles 324 may include iron, silver, cobalt, semiconducting materials and/or metals such as silicon and/or the like. In some instances, CNTs may also be used as a support material for the second nanoparticles 324. For example, the second nanoparticles 324 may be immobilized (such as by decoration, deposition, surface modification or the like) onto exposed surfaces of CNTs and/or other carbonaceous materials. The second nanoparticles 324 may react with chemically available carbon on exposed surfaces of the CNTs and/or other carbonaceous materials, for example, as shown by the cobalt-decorated carbon-growths depicted in FIG. 8.

In various implementations, the first aggregates 312 and/or the second aggregates 322 may be a relatively large particle formed by many relatively small particles bonded or fused together. As a result, the external surface area of the relatively large particle may be significantly smaller than combined surface areas of the many relatively small particles. The forces holding an aggregate together may be, for example, covalent, ionic bonds, or other types of chemical bonds resulting from the sintering or complex physical entanglement of former primary particles.

As discussed above, the first aggregates 312 may join together to form the first porous structure 316, and the second aggregates 322 may join together to form the second porous structure 326. The electrical conductivity of the first porous structure 316 may be associated with the concentration level of the first aggregates 312 within the first porous structure 316, and the electrical conductivity of the second porous structure 326 may be associated with the concentration level of the second aggregates 322 the second porous structure 326. For example, the concentration level of the first aggregates 312 may cause the first porous structure 316 to have a relatively high electrical conductivity, and the concentration level of the second aggregates 322 may cause the second porous structure 326 to have a relatively low electrical conductivity (such that the first porous structure 316 has a greater electrical conductivity than the second porous structure 326). The resulting differences in electrical conductivities of the first and second porous structures 316 and 326 may create an electrical conductivity gradient across the electrode 300. In some implementations, the electrical conductivity gradient may be used to control or adjust electrical conduction throughout the electrode 300 and/or one or more operations of the battery 100 of FIG. 1.

As used herein, aggregates may be referred to as “secondary particles,” and the original source particles may be referred to as “primary particles.” As shown in FIG. 1, FIGS. 8 to 10, and elsewhere throughout the present disclosure, the primary particles may be or include multiple graphene sheets, layers and/or nanoplatelets fused and/or joined together. Thus, in some instances, carbon nano-onions (CNOs), carbon nano-tubes (CNTs), and/or other tunable structure carbon materials may be used to form the primary particles. In some aspects, some aggregates may have a principal dimension (such as a length, a width, and/or a diameter) between approximately 500 nm and 25 μm. Also, some aggregates may include innately-formed smaller collections of primary particles, referred to as “innate particles,” of graphene sheets, layers and/or nanoplatelets joined together at orthogonal angles. In some instances, these innate particles may each have a respective dimension between approximately 50 nm and 250 nm.

The surface area and/or porosity of these innate particles may be imparted by secondary processes, such as carbon-activation by thermal processes, carbon dioxide (CO₂) treatment, and/or hydrogen gas (H₂) treatment. In some implementations, the first porous structure 316 and/or the second porous structure 326 may be derived from a carbon-containing gaseous species that can be controlled by gas-solid reactions under non-equilibrium conditions. Deriving the first porous structure 316 and/or the second porous structure 326 in this manner may involve recombination of carbon-containing radicals formed from the controlled cooling of carbon-containing plasma species (which can be generated by excitement or compaction of feedstock carbon-containing gaseous and/or plasma species in a suitable chemical reactor).

In some implementations, the first aggregates 312 and/or the second aggregates 322 may have a percentage of carbon to other elements, except hydrogen, within each respective aggregate of greater than 99%. In some instances, a median size of each aggregate may be between approximately 0.1 microns and 50 microns. The first aggregates 312 and/or the second aggregates 322 may also include metal organic frameworks (MOFs).

In some aspects, the first thin film 310 and/or the second thin film 320 (as well as any additional thin films disposed on their respective immediately preceding thin film) may be created as a layer of material and/or aggregates. The layer may range from fractions of a nanometer (in instances of a monolayer) to several microns in thickness, such as between approximately 0 and 5 microns, between approximately 5 and 10 microns, between approximately 10 and 15 microns, or greater than 15 microns. Any of the materials and/or aggregates disclosed herein, such as CNOs, may be incorporated into the first thin film 310 and/or the second thin film 320 to result in the described thickness levels.

In some implementations, the first thin film 310 may be deposited onto the second substrate 102 of FIG. 1 by chemical deposition, physical deposition, or grown layer-by-layer through techniques such as Frank-van der Merwe growth, Stranski-Krastonov growth, Volmer-Weber growth and/or the like. In other implementations, the first thin film 310 may be deposited onto the second substrate 102 by epitaxy or other suitable thin-film deposition process involving the epitaxial growth of materials. The second thin film 320 and/or subsequent thin films may be deposited onto their respective immediately preceding thin film in a manner similar to that described with reference to the first thin film 310.

In some implementations, the first porous structure 316 and second porous structure 326 may collectively define a host structure 328, for example, as shown in FIG. 3. In some instances, the host structure 328 may be based on a carbon scaffold and/or may include decorated carbons, for example, as shown in FIG. 8. The host structure 328 may provide structural definition to the electrode 300. In some instances, the host structure 328 may be fabricated as a positive electrode and used in the cathode 110 of FIG. 1. In other implementations, the host structure 328 may be fabricated as a negative electrode and used in the anode 120 of FIG. 1. In some instances, the host structure 328 may include pores having sizes, such as micro-, meso-, and/or macro pores according to IUPAC definitions, with at least some micropores sized at approximately 1.5 nm in width for pre-loading of sulfur and/or to temporarily microconfine polysulfides (PS) that may be generated during operational cycling.

The host structure 328, when provided within the electrode 300 as shown in FIG. 3, may include micro-, meso-, and/or macro-porous pathways created by exposed surfaces and/or contours of the first porous structure 316 and/or the second porous structure 326. These pathways may allow the host structure 328 to receive the electrolyte 180 for example, by transporting lithium ions towards the cathode 110 of the battery 100. Specifically, the electrolyte 180 may infiltrate the various porous pathways of the host structure 328 and uniformly disperse throughout the electrode 300 and/or other portions of the battery 100. Infiltration of the electrolyte 180 into such regions of the host structure 328 permits lithium ions, such as those migrating from the anode 120 toward the cathode 110, to form lithium-sulfur complexes with elemental sulfur pre-loaded into pores of the cathode 110. As a result, the elemental sulfur may retain additional quantities of lithium ions than otherwise achievable by non-sulfur chemistries, such as lithium cobalt oxide (LiCoO) or other lithium-ion cells, which may rely on carbon scaffolding alone to provide suitable retention surfaces and orifices for lithium.

In some aspects, each of the first porous structure 316 and/or the second porous structure 326 may have a porosity created by one or more of a thermal process, a carbon dioxide (CO₂) gas treatment, or a hydrogen gas (H₂) treatment. Specifically, the micro, meso, and macro porous pathways of the host structure 328 of the electrode 300 may include macroporous pathways, mesoporous pathways, and/or microporous pathways, for example, in which the macroporous pathways have a principal dimension greater than 50 nm, the mesoporous pathways have a principal dimension between approximately 20 nm and 50 nm, and the microporous pathways have a principal dimension less than 4 nm. As such, the macroporous pathways and mesoporous pathways can provide tunable conduits for transporting lithium ions 125, and the microporous pathways may confine active materials within the electrode 300.

In some implementations, the electrode 300 may include more than two thin films such as one or more additional thin films. Each of the one or more additional thin films may include individual aggregates interconnected with each other across different thin films, with at least some of the thin films having different concentration levels of aggregates. As a result, the concentration levels of any thin film may be varied (such as by gradation) to achieve particular electrical resistance (or conductance) values. For example, in some implementations, the concentration levels of aggregates may progressively decline between the first thin film 310 and the last thin film (such as in a direction from the second substrate 102 toward the separator 150 and the first substrate 101 of the battery 100 of FIG. 1) and/or the individual thin films may have an average thickness between approximately 10 microns and approximately 200 microns. In addition, or in the alternative, the first thin film 310 may have a relatively high concentration of carbon-based aggregates, and the second thin film 320 may have a relatively low concentration of carbon-based aggregates. In some aspects, the relatively high concentration of aggregates corresponds to a relatively low electrical resistance, and the relatively low concentration of aggregates corresponds to a relatively high electrical resistance.

The host structure 328 may be prepared with multiple active sites on exposed surfaces of the first aggregates 312 and/or the second aggregates 322. These active sites, as well as the exposed surfaces of the first aggregates 312 and/or the second aggregates 322, may be configured for ex-situ electrodeposition, such as electroplating, prior to incorporation of the electrode 300 into the battery 100. Electroplating is a process that creates a lithium layer 330 (including lithium on exposed surfaces of the host structure 328) through chemical reduction of metal cations by application of a direct current. In implementations where the electrode 300 is configured to serve as the anode 120 of the battery 100 in FIG. 1, the host structure 328 may be electroplated such that the lithium layer 330 has a thickness between approximately 1 and 5 micrometers (μm), 5 μm and 20 μm, or greater than 20 μm. In some instances, ex-situ electrodeposition may be performed at a location separate from the battery 100 prior to the assembly of the battery 100.

In various implementations, excess lithium provided by the lithium layer 330 may increase the number of lithium ions 125 available for transporting in the battery 100, thereby increasing the storage capacity, longevity, and performance of the battery 100 (as compared with traditional lithium-ion and/or lithium-sulfur batteries).

In some aspects, the lithium layer 330 may be configured to produce lithium-intercalated graphite (LiC₆) and/or lithiated graphite based on chemical reactions with the first aggregates 312 and/or the second aggregates 322. Lithium intercalated between alternating graphene layers may migrate or be transported within the electrode 300 due to differences in electrochemical gradients during operational cycling of the battery 100, which in turn may increase the energy storage and power delivery of the battery 100.

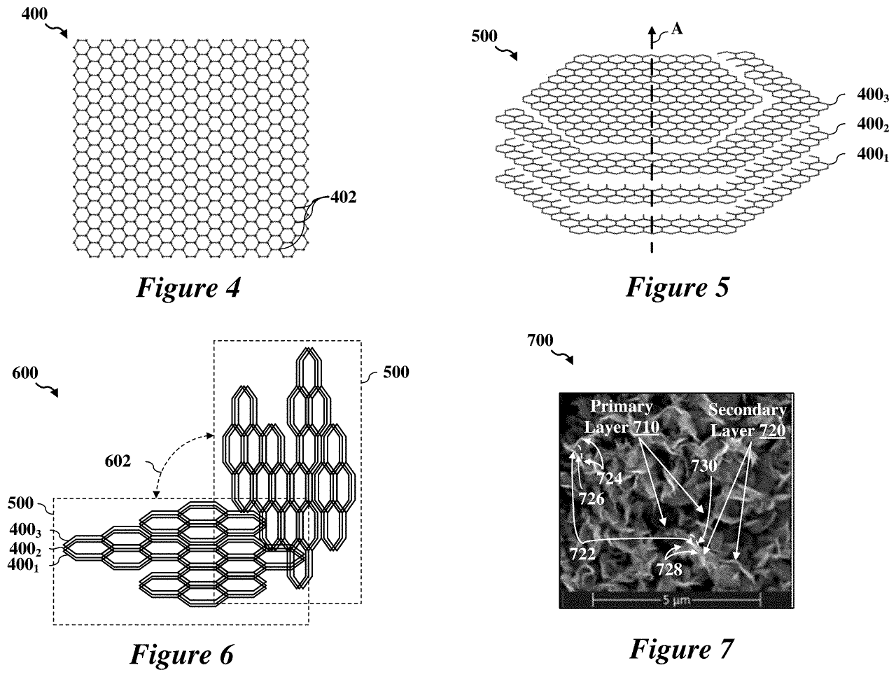

FIG. 4 shows an example graphene 400, according to some implementations. The graphene 400 may include a single layer of carbon atoms with each atom bound to three neighbors in a honeycomb structure. In some aspects, the single layer may be a discrete material restricted in one dimension, such as within or at a surface of a condensed phase. For example, the graphene 400 may grow outwardly only in the x and y planes (and not in the z plane). In some aspects, the graphene 400 may be a two-dimensional (2D) material, including one or several layers with the atoms in each layer strongly bonded (such as by a plurality of carbon-carbon bonds 402) to neighboring atoms in the same layer.

In some instances, the graphene 400 may be stacked on top of itself to form a bulk material, such as graphite including multiple discrete graphene stacked parallel to each other in a three dimensional, crystalline, long-range order. The number of discrete graphene in the resulting bulk material may depend on one or more properties of the material. In the case of layers of the graphene 400, each layer of the graphene 400 may be a 2D material including up to 10 layers. In some implementations, the graphene 400 shown in FIG. 2 may join together with other instances of the graphene 400 in a suitable chemical reactor to form other carbon structures. These materials may be used as building blocks to form any of the first aggregates 312 and/or the second aggregates 322 of FIG. 1.

FIG. 5 shows an example of a graphene nanoplatelet 500, according to some implementations. In some instances, the graphene nanoplatelet 500 may include multiple instances of the graphene 400 of FIG. 4, such as a first graphene layer 400₁, a second graphene layer 400₂, and a third graphene layer 400₃, all stacked on top of each other in a vertical direction denoted by arrow A in FIG. 5. The graphene nanoplatelet 500, which may be referred to as a GNP, may have a thickness between 1 nm and 3 nm, and may have lateral dimensions ranging from approximately 100 nm to 100 μm. In some implementations, the graphene nanoplatelet 400 may be produced by multiple plasma spray torches arranged sequentially by roll-to-roll (R2R) production. In some aspects, R2R production may include deposition upon a continuous substrate that is processed as a rolled sheet, including transfer of 2D material(s) to a separate substrate. In some instances, the R2R production may be used to form the first thin film 310 and/or the second thin film 320, for example, each having different concentration levels of the first aggregates 312 and/or the second aggregates 322. That is, the plasma spray torches used in the R2R processes may spray carbonaceous materials at different concentration levels to create the first thin film 310 and/or the second thin film 320 using specific concentration levels of graphene nanoplatelets 500. Therefore, R2R processes may provide for a fine level of tunability for the battery 100 of FIG. 1.

FIG. 6 shows several graphene nanoplatelets 500 of FIG. 5 joined together to form an aggregate 600, according to some implementations. The graphene nanoplatelets 500 used to form the aggregate 600 may be joined together at an angle 602. In some aspects, the angle 602 may be orthogonal, such as approximately 90 degrees relative from an initial instance of the graphene nanoplatelet 500 to a subsequent instance of the graphene nanoplatelet 500. The angle 602 at which various instances of the graphene nanoplatelet 500 join together may be created during synthesis of the aggregate 600 and/or the graphene nanoplatelet 500 within, for example, a reactor.

FIG. 7 is a micrograph 700 showing carbonaceous materials suitable for use in the electrode 300 of FIG. 3, according to some implementations. The micrograph 700 shows a primary layer 710 and a secondary layer 720, each including and/or being formed from various instances of the graphene 400 of FIG. 4 joined together to form larger structures. Such larger structures may, for example, include various instances of the graphene nanoplatelet 500 and/or the aggregate 600. In some implementations, a 3D innate carbon-based growth may include the primary layer 710. In some instances, the primary layer 510 may be formed from interconnected instances of the aggregate 600 of FIG. 6 and/or any aggregate of the first aggregates 312 and/or the second aggregates 322 of the electrode 300 of FIG. 3.

The secondary layer 720 may be disposed on the primary layer 710 and may include a non-concentric co-planar junction 722. In some aspects, the non-concentric co-planar junction 722 may include a first layer of platelets 724 joined together. Each platelet 724 may be, for example, the graphene nanoplatelet 500 and/or the aggregate 600 and may have similar dimensionality to adjacent platelets connected together (such as to form the first layer of platelets 524) at respective non-concentration co-planar junctions 722. Each platelet of the first layer of platelets 724 may be oriented to other platelets at a first angle 726. In addition, a second layer of platelets 728 may extend from the first layer of platelets 724 at respective non-concentric co-planar junctions 722 at a second angle 730. In some aspects, the second angle 730 may be different than the first angle 726. In addition, or in the alternative, the primary layer 710 may be rotated relative to the secondary layer 720 by approximately 90 degrees.

FIG. 8 is a micrograph 800 of a carbon-based scaffold 802, according to some implementations. The carbon-based scaffold 802 may be incorporated in any of the carbonaceous structures described in the present disclosure. In some aspects, the carbon-based scaffold 802 may be decorated with a plurality of cobalt nanoparticles 804. The carbon-based scaffold 802 may be constructed from growths of the carbonaceous materials shown in the micrograph 700 of FIG. 7, such as the primary layer 710 and/or the secondary layer 720. In contrast to a 2D graphene material, the carbon-based scaffold 802 has a convoluted 3D structure that can prevent graphene restacking, thereby avoiding drawbacks of only using 2D graphene layers as a formative material. This process also increases the areal density of the materials, yielding higher electroactive (such as lithium) material adsorption and/or reaction (such as intercalation to form lithiated graphite) sites per unit area, thereby improving the specific capacity of the host structure 328 of the electrode 300 shown in FIG. 3.

The carbon-based scaffold 802 shown in FIG. 8 may be produced using flow-through type microwave plasma reactors configured to create pristine 3D graphene particles continuously from a hydrocarbon gas at near atmospheric pressures. Operationally, as the hydrocarbon flows through a relatively hot zone of a plasma reactor, free carbon radicals may be formed that flow further down the length of the reactor into the growth zone where 3D carbon particulates (based on multiple 2D graphenes joined together) are formed and collected as fine powders. The density and composition of the free-radical carbon-inclusive gaseous species may be tuned by gas chemistry and microwave power levels. By controlling the reactor process parameters, these reactors may produce carbons with a wide, yet tunable, range of physical characteristics, such as shape, crystalline order, and sizes (and distributions). For example, possible sizes and distributions may range from flakes (from a few 100 nm to one or more microns in width and a few nm in thickness) to spherical particles (such as having a diameter between approximately 10 nm and 100 nm) to graphene clusters (such as having a diameter between approximately 10 and 100 μm). The 3D nature of the materials prevents agglomeration in certain circumstances, thereby effectively allowing for the materials to be disseminated as un-agglomerated particles. As a result, highly convoluted materials having a high exposed surface area per unit volume can be produced. Graphene, an atomically 2D material, has many advantageous properties for sensing, including outstanding chemical and mechanical strength, high carrier mobility, high electrical conductivity, high surface area, and gate-tunable carrier density.

In some aspects, the carbon-based scaffold 802 may include CNO oxides organized as a monolithic and/or interconnected growth and be produced in a thermal reactor. The carbon-based scaffold 802 may be decorated with cobalt nanoparticles 804 according to the following example recipe: cobalt(II) acetate (C₄H₆CoO₄), the cobalt salt of acetic acid (often found as tetrahydrate Co(CH₃CO₂)₂.4H₂O, which may be abbreviated as Co(OAc)₂.4H₂O, may be flowed into the thermal reactor at a ratio of approximately 59.60 wt % corresponding to 40.40 wt % carbon (referring to carbon in CNO form), resulting in the functionalization of active sites on the CNO oxides with cobalt, showing cobalt-decorated CNOs at a 15,000× level, respectively. In some implementations, suitable gas mixtures used to produce Carbon #29 and/or the cobalt-decorated CNOs may include the following steps:
Ar purge 0.75 standard cubic feet per minute (scfm) for 30 min;
Ar purge changed to 0.25 scfm for run;
temperature increase: 25° C. to 300° C. 20 mins; and
temperature increase: 300°-500° C. 15 mins.

FIG. 9 shows a micrograph 900 of a plurality of CNOs 902, according to some implementations. In various implementations, each CNO 902 may have a core region 904 with a carbon growth and/or layering. In some instances, the CNOs 902 may be multi-layered fullerenes. The shape, size, and layer count, such as layers of the graphene 400 of FIG. 4, may depend on manufacturing processes. The plurality of CNOs 902 may, in some aspects, demonstrate poor water solubility. As such, in some implementations, non-covalent functionalization may be utilized to alter one or more dispersibility properties of the plurality of CNOs 902 without affecting the intrinsic properties of formative sp² carbon nanomaterial in each CNO 902. In some aspects, the plurality of CNOs 902 may be grown from the aggregate 600 of FIG. 6 and/or may form the first aggregates 312 and/or the second plurality of aggregates 322. Each CNO 902 may have a diameter between approximately 50 and 75 μm.

FIG. 10 shows a micrograph 1000 of an aggregate 1004 formed from joining several CNOs of a plurality of CNOs 1002 together, according to some implementations. For example, exterior carbon-containing shell-type layers of each CNO 1002 may fuse together with carbons provided by other carbon-containing shell-type layers of other CNOs 1002 to form an aggregate 1004. In some aspects, a core region 1006 of each of the CNOs 1002 may be tunable. For example, the core region 1006 may have a concentration level of interconnected graphenes, such as multiple instances of the graphene 400 of FIG. 4. As a result, some of the plurality of CNOs 1002 may have a first concentration 1010 of interconnected carbons approximately between 0.1 g/cc and 2.3 g/cc at or near a shell of the respective CNO 1002. Each of the CNOs 1002 may have a plurality of pores configured to transport lithium ions extending inwardly from the first concentration 1010 toward and/or from the core region 1006.

In some implementations, each pore may have a width or dimension between approximately 0.0 nm and 0.5 nm, between approximately 0.0 and 0.1 nm, between approximately 0.0 and 6.0 nm, or between approximately 0.0 and 35 nm. Each CNO of the plurality of CNOs 1002 may also have a second concentration 1012 at the core region 1006 of interconnected carbons. The second concentration 1012 may include a plurality of relatively lower-density regions arranged concentrically. The second concentration 1012 may be lower than the first concentration 1010 between approximately 0.0 g/cc and 1.0 g/cc or between approximately 1.0 g/cc and 1.5 g/cc. The relationship between the first concentration 1010 and the second concentration 1012 may increase the ability to enclose and/or confine sulfur or lithium polysulfides (PS). For example, sulfur and/or lithium polysulfides may travel through the first concentration 1010 and be at least temporarily confined within and/or interspersed throughout the second concentration 1012 during operational cycling of a lithium-sulfur battery.

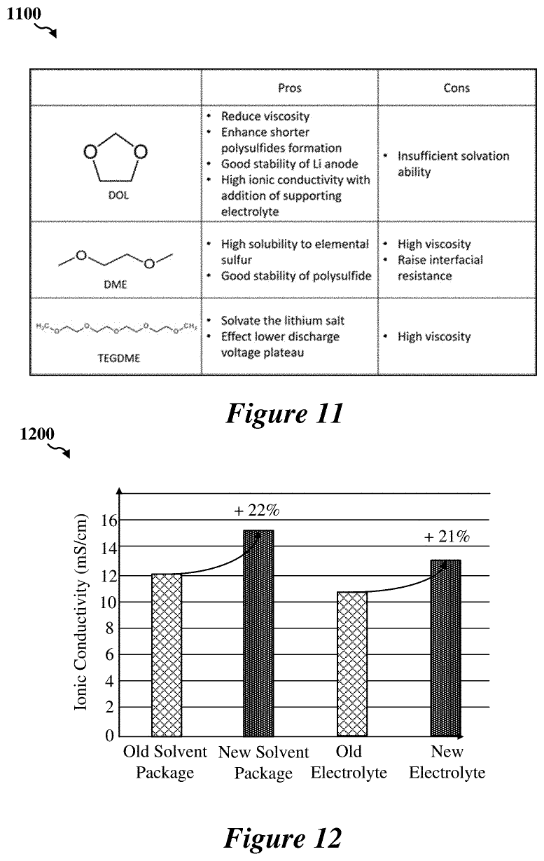

FIG. 11 shows an example table 1100, according to some implementations. The table 1100 lists several chemical compounds (DOL, DME, and TEGDME) which may be used as constituent species and/or solvents within, for example, the electrolyte 130 of the battery 100 of FIG. 1. In some implementations, adjustments of the solvents may improve sulfur utilization and mitigate shuttling of polysulfides in the electrolyte 130. In addition, formation of the solid-electrolyte interphase layer 140 may be affected by solvent selection. As a result, various concentrations, dilutions and/or mixtures of the solvents, referred to as “solvent packages,” may be developed to match with porosity values of, for example, the electrode 300.

Pros for DOL include reducing viscosity of the electrolyte 130. Lower viscosity levels of the electrolyte 130 may permit easier flow of ions, such as lithium ions, to and from the cathode and anode. Other example pros of DOL include improvements in formation of shorter polysulfides during battery cycling. The shorter polysulfides may be easier to confine within specific regions of the electrode 300 and/or the cathode 110 relative to their long-chain polysulfide counterparts, thereby improving overall performance of the battery 100. DOL also imparts stability to solid lithium metal anodes, such as the anode 220 of the battery 200 of FIG. 2, as well as providing a relatively high lithium ionic conductivity with the addition of one or more additional (also referred to as “supporting”) electrolytes. One con of DOL is an insufficient solvation ability, such as failing to completely dissolve additional molecules, such as additives that may be provided to improve ionic conductivities of electrolyte mixtures.

Pros for DME include providing relatively high solubility to elemental sulfur. DME may also, due to its chemical structure and/or other properties, provide stability to polysulfides suspended in DME. However, DME also presents several cons, including having a relatively high viscosity and raising interfacial resistance, which may prevent facile ionic flow.

Pros for TEGDME include providing solvation capabilities for lithium salts, thereby allowing for free formation and flow of lithium ions. TEGDME also provides a lower discharge voltage plateau, but suffers from a high viscosity, which may impede ionic flow. In some implementations, various dilution ratios, concentrations, and volumes of DOL, DME, and/or TEGDME may be mixed together, in liquid-phase, at room temperature to produce any of the presently disclosed mixtures or compositions.

FIG. 12 shows a graph 1200 depicting performance of various substances, according to some implementations. The “old solvent package” is prepared as 1 molar (M) lithium bis(trifluoromethanesulfonyl)imide (LiTFSI) in DME:DOL:TEGDME prepared at an approximate volume ratio of (volume:volume:volume=1:1:1). The new solvent package is prepared as 1 M LiTFSI in DME:DOL:TEGDME (volume:volume:volume=58:29:13). In one implementation, lithium nitrate (LiNO₃) is dissolved in the presented solvent packages to transform them into electrolytes. As a result, the “old electrolyte” is the 1 M LiTFSI in DME:DOL:TEGDME (volume:volume:volume=1:1:1) with 2 wt. % LiNO₃. The “new electrolyte” is the 1 M LiTFSI in DME:DOL:TEGDME (volume:volume:volume=58:29:13) with 2 wt. % LiNO₃.

As shown in the graph 1200, the new solvent package demonstrates an approximate 22% performance improvement in ionic conductivity measured in milli-siemens per centimeter (mS/cm). The new electrolyte demonstrates an approximate 21% performance improvement in ionic conductivity measured in mS/cm. The new electrolyte may be used in any of the presently disclosed battery and/or electrochemical cell implementations, such as with the electrode 300 of FIG. 3 and/or the battery 100 of FIG. 1, to improve battery performance and longevity. In one implementation, the new electrolyte may be interspersed throughout the electrode 300, which may be implemented as the cathode 110 of the battery 100. In this implementation, the new electrolyte may also contact the anode 120, thereby allowing for the lithium ions 125 to freely flow back and forth in the electrolyte 130 during battery cycling.

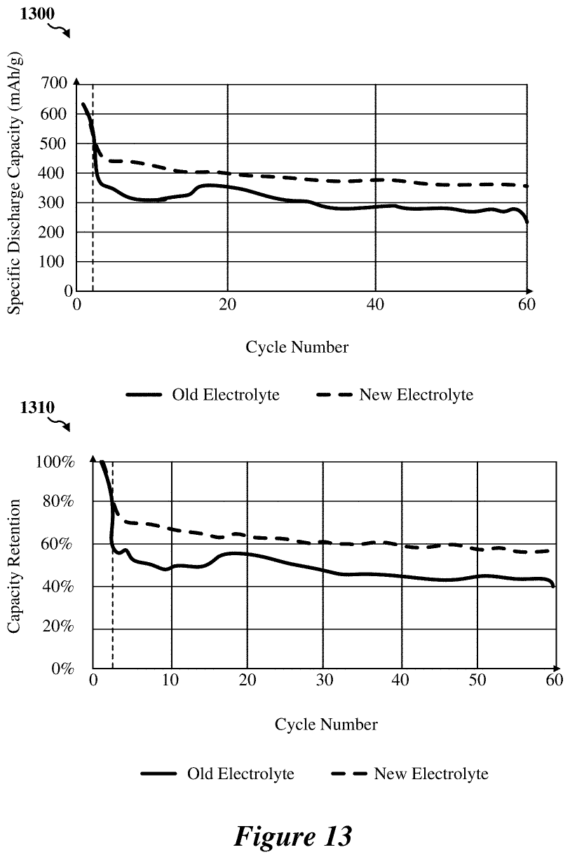

FIG. 13 shows a first graph 1300 and a second graph 1310, according to some implementations. The first graph 1300 and the second graph 1310 depict battery performance per cycle number, such as for the battery 100 of FIG. 1. The first graph 1300 shows improvements in specific discharge capacity. The second graph shows capacity retention in percent (%). In the first graph 1300 and the second graph 1310, the “old electrolyte” is prepared as 1 M LiTFSI in DME:DOL:TEGDME (volume:volume:volume=1:1:1) with 2 wt. % LiNO₃, and the “new electrolyte” is prepared as 1 M LiTFSI in DME:DOL:TEGDME (volume:volume:volume=58:29:13) with approximately 2 wt. % LiNO₃.

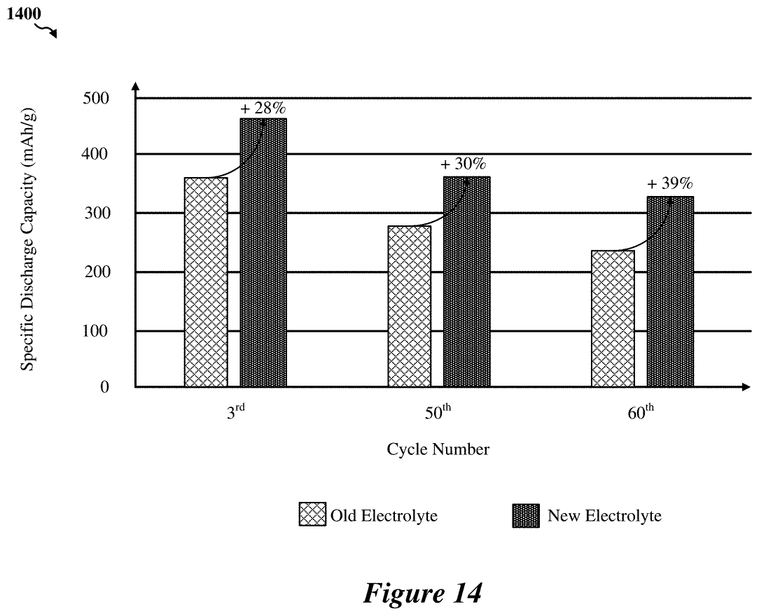

FIG. 14 shows a graph 1400, according to some implementations. The graph 1400 depicts capacity improvement per cycle number, such as for the battery 100 of FIG. 1. In the graph 1400, the “old electrolyte” is prepared as 1 M LiTFSI in DME:DOL:TEGDME (volume:volume:volume=1:1:1) with 2 wt. % LiNO₃, and the “new electrolyte” is prepared as 1 M LiTFSI in DME:DOL:TEGDME (volume:volume:volume=58:29:13) with 2 wt. % LiNO₃. The graph 1400 depicts capacity improvement provided by the new electrolyte as approximately 28% at the 3^{rd} cycle number, as approximately 30% at the 50^{th} cycle number, and as approximately 39% at the 60^{th} cycle number for the new electrolyte compared to the old electrolyte.

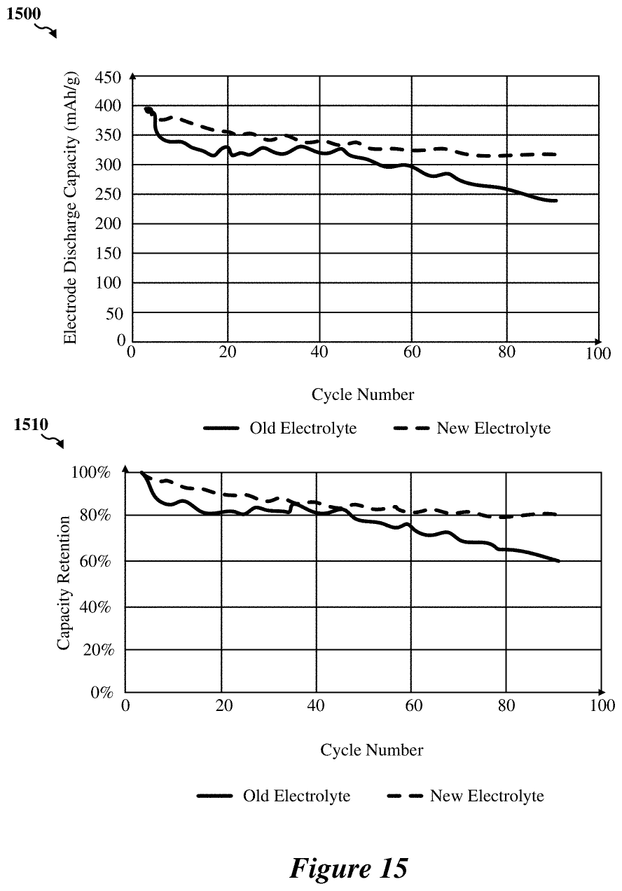

FIG. 15 shows a first graph 1500 and a second graph 1510, according to some implementations. The first graph 1500 and the second graph 1510 depict battery performance per cycle number, such as for the battery 100 of FIG. 1. The first graph 1500 and the second graph 1510 depict performance of the battery 100 when configured as a lithium-sulfur coin cell. The battery 100 is cycled at a discharge rate of 1 C (such as fully discharged within one hour), at 100% depth-of-discharge (DOD) and is kept at approximately at room temperature (68° F. or 20° C.). The “old electrolyte” is prepared as 1 M LiTFSI in DME:DOL:TEGDME (volume:volume:volume=1:1:1) with 2 wt. % LiNO₃, and the “new electrolyte” is prepared as 1 M LiTFSI in DME:DOL:TEGDME (volume:volume:volume=58:29:13) with approximately 2 wt. % LiNO₃.

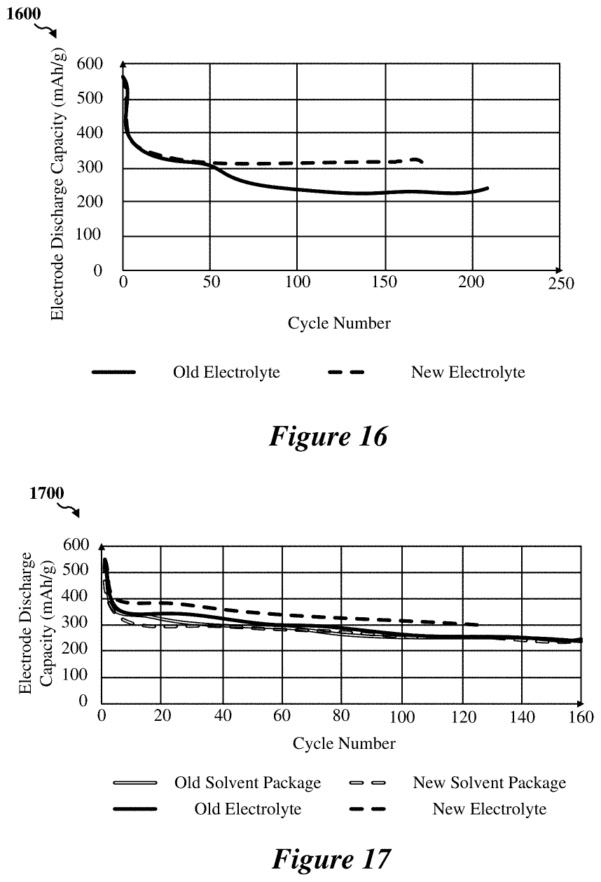

FIG. 16 shows a graph 1600, according to some implementations. The graph 1600 depicts improvements in discharge capacity per cycle number, such as for the battery 100 of FIG. 1. The “old electrolyte” is prepared as 1 M LiTFSI in DME:DOL:TEGDME (volume:volume:volume=1:1:1) with 2 wt. % LiNO₃, and the “new electrolyte” is prepared as 1 M LiTFSI in DME:DOL:TEGDME (volume:volume:volume=58:29:13) with approximately 2 wt. % LiNO₃.

FIG. 17 shows a graph 1700, according to some implementations. The graph 1700 depicts improvements in discharge capacity per cycle number, such as for the battery 100 of FIG. 1. The “old solvent package” is prepared as 1 M LiTFSI in DME:DOL:TEGDME (volume:volume:volume=1:1:1), and the “new solvent package” is prepared as 1 M LiTFSI in DME:DOL:TEGDME (volume:volume:volume=58:29:13). The “old electrolyte” is prepared as 1 M LiTFSI in DME:DOL:TEGDME (volume:volume:volume=1:1:1) with approximately 2 wt. % LiNO₃, and the “new electrolyte” is prepared as 1 M LiTFSI in DME:DOL:TEGDME (volume:volume:volume=58:29:13) with 2 wt. % LiNO₃.

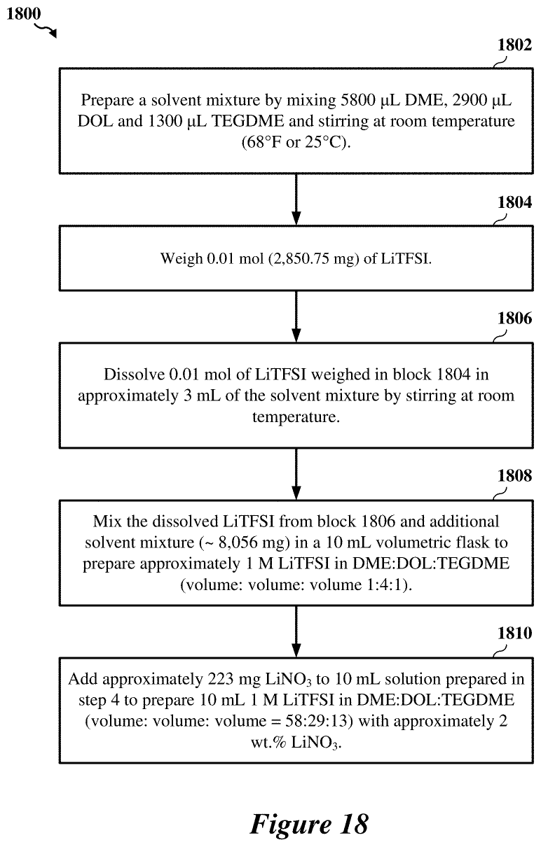

FIG. 18 shows an example process 1800 for preparing a solvent package, such as any of the ternary solvent packages presented in FIGS. 12 to 17, according to some implementations. As described earlier, the ternary solvent package may include DME, DOL and TEGDME. At block 1802, a solvent mixture may be prepared by mixing 5800 μL DME, 2900 μL DOL and 1300 μL TEGDME and stirring at room temperature (68° F. or 25° C.). At block 1804, 0.01 mol (2,850.75 mg) of LiTFSI may be weighed. At block 1806, the 0.01 mol of LiTFSI weighed in block 1804 may be dissolved in approximately 3 mL of the solvent mixture by stirring at room temperature. At block 1808, the dissolved LiTFSI from block 1806 and additional solvent mixture (˜8,056 mg) may be mixed in a 10 mL volumetric flask to prepare approximately 1 M LiTFSI in DME:DOL:TEGDME (volume:volume:volume 1:4:1). At block 1810, approximately 223 mg LiNO₃ may be added to 10 mL solution prepared in step 4 to prepare 10 mL 1 M LiTFSI in DME:DOL:TEGDME (volume:volume:volume=58:29:13) with approximately 2 wt. % LiNO₃.

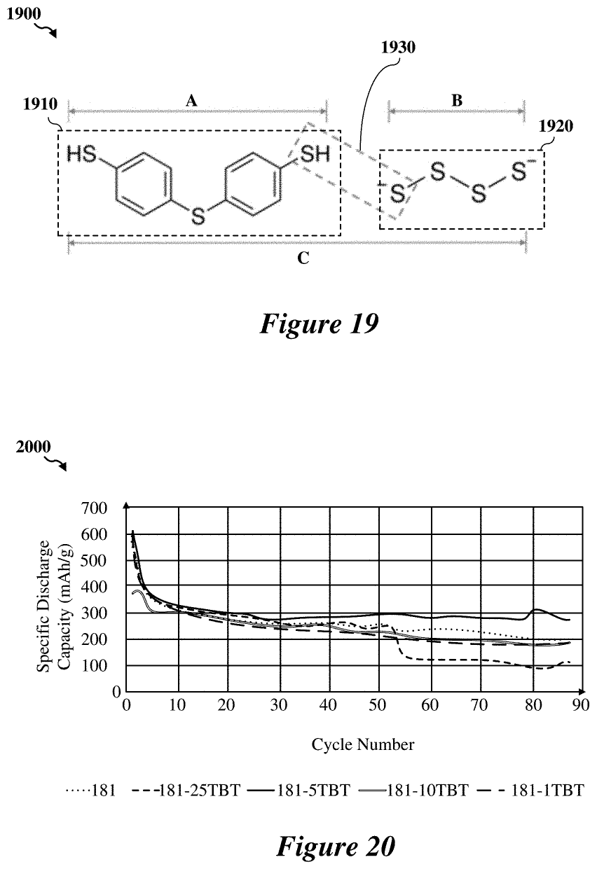

FIG. 19 shows an example complex 1900 formed from binding, with a sulfur-sulfur chemical bond 1930, a 4,4′-Thiobisbenzenethiol (TBT) 1910 with a polysulfide intermediate 1920, according to some implementations. The TBT 1910 has a molecular formula of C₁₂H₁₀S₃ and a molecular weight of approximately 250.4 g/mol. The TBT 1910 has a maximum dimension A of approximately 1.5 nm. The polysulfide intermediate 1920 has a maximum dimension of greater than 0.5 nm. The TBT 1910, when complexed with the polysulfide intermediate 1920 to create the complex 1900, has a maximum dimension of approximately 2 nm.

In some implementations, the complex 1900, with an approximate maximum dimension of 2 nm, may be used to bind to polysulfide intermediates, such the polysulfide intermediate 1920, which may be created during battery cycling of the battery 100 of FIG. 1. The TBT 1910, when infiltrated into pores of cathode 110 (when prepared as the electrode 300), may bind to the polysulfide intermediate 1920 by the sulfur-sulfur chemical bond 1930 to create the complex 1900. Accordingly, the complex 1900 (and other instances of the complex 1900) may become lodged within pores of an approximate width of 2 nm within the cathode 110. As a result of the accumulation of instances of the complex 1900 within the pores, the cathode 110 may volumetrically expand. In some aspects, the TBT may form the sulfur-sulfur chemical bond 1930 between an edge sulfur atom on the polysulfide intermediate 1920 and a thiol functional group of the TBT 1910. Due to length-wise growth of the complex 1900, unwanted migration (or “shuttle”) of polysulfide out of the cathode 110 can be suppressed. As a result, usage of TBT in the electrolyte 130 can prevent interference and other undesirable interaction between polysulfide and the anode 120, such as that encountered due to polysulfide shuttle.

FIG. 20 shows a graph 2000 for specific discharge capacity for various TBT-containing electrolyte mixtures, according to some implementations. As shown in the graph 2000, “181” indicates an electrolyte without any TBT additions, resulting in a 0 M TBT concentration level, “181-25TBT” indicates an electrolyte prepared at a 25 M TBT concentration level and so on and so forth. In some implementations, a 5M TBT concentration level may result in an approximate 70 mAh/g discharge capacity increase, as shown by comparison of “181-5TBT” relative to “181.”

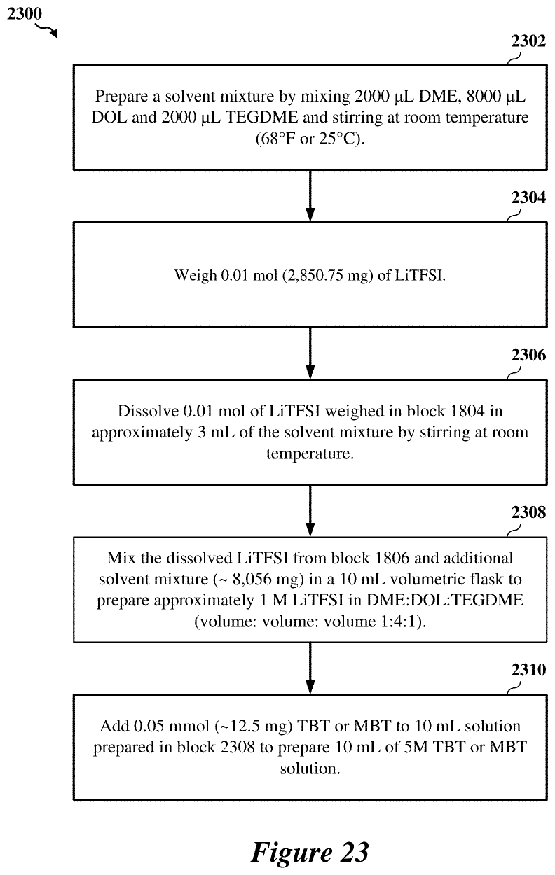

FIG. 21 shows a first graph 2100 and a second graph 2110, according to some implementations. The first graph 2100 depicts specific discharge capacity (mAh/g) per cycle number and the second graph 2110 depicts capacity retention (%) per cycle number. The first graph 2100 and the second graph 2110 may show performance improvements of the battery 100 of FIG. 1 and/or other battery configurations presented in the present disclosure. Regarding the first graph 2100 and the second graph 2110, the “old electrolyte” refers to electrolytes consisting of DOL, DME and TEGME in equal (1:1:1) volume ratios and the “new electrolyte” refers to, for example, the electrolyte 130, prepared with a 5 molar (M) concentration level of TBT (or MBT, substituted for TBT) according to the process 2300 shown in FIG. 23.

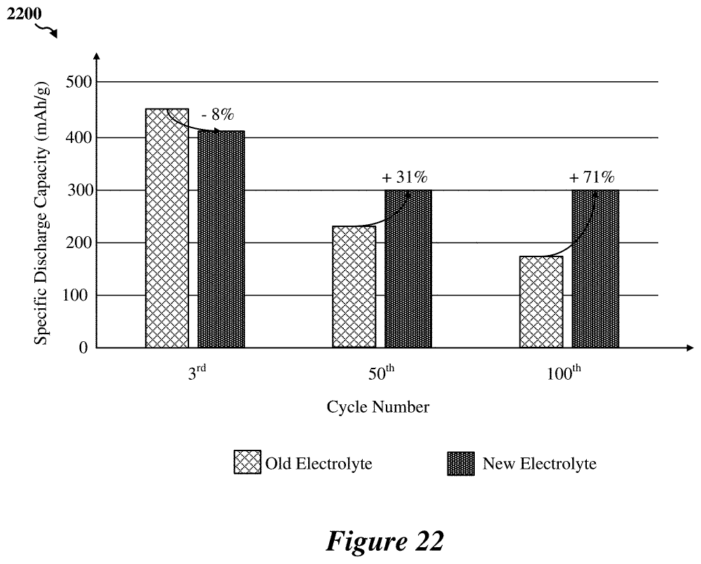

FIG. 22 shows a bar chart 2200, according to some implementations. The bar chart 2200 depicts specific discharge capacity improvement of a battery, such as the battery 100 of FIG. 1, prepared with the electrolyte 130 at a 5M TBT (or MBT, substituted for TBT) concentration level. The “old electrolyte” refers to electrolytes consisting of DOL, DME and TEGME in equal (1:1:1) volume ratios and the “new electrolyte” refers to the electrolyte 130, prepared with a 5 molar (M) concentration level of TBT (or MBT, substituted for TBT) according to the process 2300 shown in FIG. 23.

FIG. 23 shows an example process 2300 for preparing a solvent package including TBT or MBT, such as any of the ternary solvent packages including TBT or MBT presented in FIGS. 12 to 17, according to some implementations. As described earlier, the ternary solvent package may include DME, DOL, TEGDME, and TBT or MBT. At block 2302, a solvent mixture may be prepared by mixing 2000 μL DME, 8000 μL DOL and 2000 μL TEGDME and stirring at room temperature (68° F. or 25° C.). At block 2304, 0.01 mol (2,850.75 mg) of LiTFSI may be weighed. At block 2306, the 0.01 mol of LiTFSI weighed in block 2304 may be dissolved in approximately 3 mL of the solvent mixture by stirring at room temperature. At block 2308, the dissolved LiTFSI from block 2306 and additional solvent mixture (˜8,056 mg) may be mixed in a 10 mL volumetric flask to prepare approximately 1 M LiTFSI in DME:DOL:TEGDME (volume:volume:volume 1:4:1). At block 2310, approximately 0.05 mmol (˜12.5 mg) TBT or MBT may be added to 10 mL solution prepared in block 2308 to prepare 10 mL of 5M TBT or MBT solution.

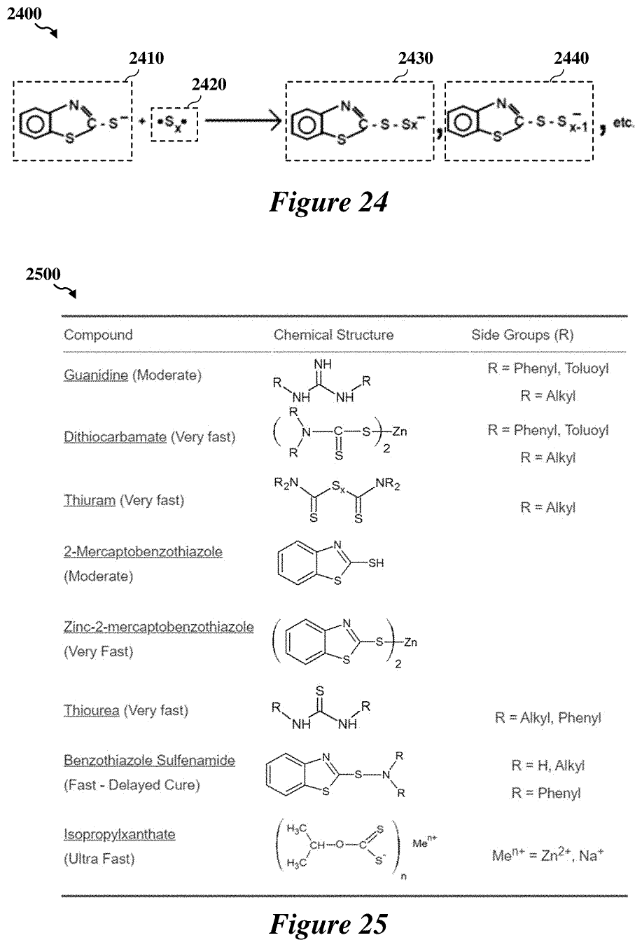

FIG. 24 shows an example chemical reaction 2400 between a 2-mercaptobenzothiazole (MBT) 2410 with a sulfur (S²⁻) ion 2420, according to some implementations. Sulfur vulcanization accelerators, such as MBT, are molecules which can open elemental sulfur (S₈) rings to chemically bind to sulfur ions in the opened rings. Electrolytes, such as the electrolyte 130 of the battery 100 of FIG. 1, may be prepared with MBT (instead of TBT) according to the process 2300 of FIG. 23. MBT-containing electrolyte may more efficiently solubilize sulfur relative to non-MBT containing electrolytes and also improve sulfur utilization. As a result, lower quantities of MBT-containing electrolytes may be required to achieve similar levels of sulfur complexation with existing polysulfides, shown by the sulfur ion 2420 in FIG. 24.

In some implementations, formed complexes between the MBT 2410 and the sulfur ions 2420, such as a first complex 2430 and a second complex 2440, may experience decreased solubility and diffusion in the MBT-containing electrolytes due to the larger molecular size of the complexes relative to the sulfur ion 2420. As a result, these larger sized complexes may become trapped in regions and/or pores of the electrode 300. The entrapment of these larger sized complexes within the cathode 110 may result in fewer complexes moving within the electrolyte 130, thereby failing to impede movement of the lithium ions 125. As a result, the entrapment of larger sized complexes within the cathode 110 increases the speed, rate, and amount of lithium ions 125 that can be transported from the anode 120 through the electrolyte 130 towards the cathode 110. Increasing the amount of freely movable and/or transportable lithium ions unimpeded by lithium-containing polysulfide intermediates in the cathode 110 may increase the energy capacity and improve electric power delivery efficiency of the battery 100.

FIG. 25 shows sulfur vulcanization accelerators 2500 and their corresponding chemical structures, according to some implementations. Any of the sulfur vulcanization accelerators 2500 may be substituted for MBT or TBT in the process 2300 shown in FIG. 23 to produce corresponding electrolytes. For example, in one implementation, the process 2300 may be performed by substituting guanidine for MBT to produce a 5M guanidine solution, which may be implemented as the electrolyte 130. Guanidine may demonstrate different reaction kinetics relative to dithiocarbamate, which may form sulfur-containing complexes with the sulfur ion 2420 prevalent within the battery 100 faster than guanidine. As a result, dithiocarbamate may be more suitable for immediate restriction of polysulfide movement. In contrast, guanidine may be more suitable for more tolerant situations where some polysulfide shuttle may be acceptable. Similar substitutions may be performed with any one of sulfur vulcanization accelerators 2500 in the process 2300 to produce corresponding electrolytes.

The sulfur vulcanization accelerators 2500 may be further classified as “primary accelerators” or “secondary accelerators.” Primary accelerators may include thiazones and sulfenamides. In some aspects, thioreas and dicarbamates can function as both primary and secondary accelerators. In one implementation, electrolyte solutions may contain both primary and secondary accelerators. In this implementation, secondary accelerators may be used to activate primary accelerators. That is, the process 2300 of FIG. 23 may be adjusted to include additions of both primary and secondary accelerators (such as in identical or different molar and/or weight quantities) to achieve various dilution levels corresponding to desired performance characteristics of the electrolyte 130.

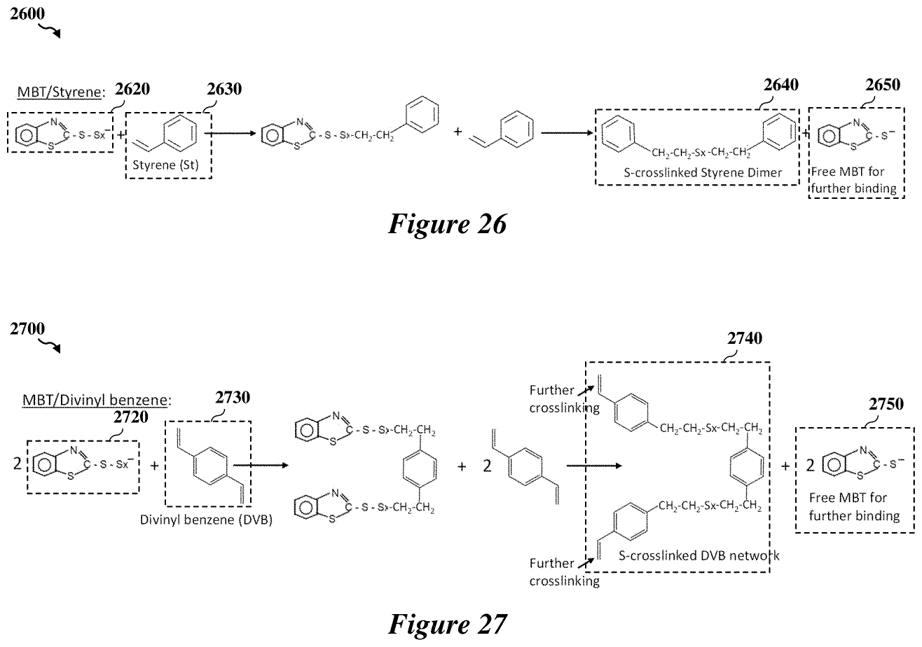

In some implementations, additional chemical molecules (not shown in FIG. 25) that contain carbon to carbon double bonds, such as vinyl or acrylate monomers, may chemically bind to the sulfur ion 2420 to increase complex size (and reduce corresponding diffusion in electrolytes). In some aspects, such chemical molecules may form larger cross-linked polymer networks capable of binding to the sulfur ions 2420 of polysulfides generated during battery cycling. In one implementation, varying monomer structure within the described larger cross-linked polymer networks may improve monomer to sulfur complexation geometry and polarity. In some aspects, MBT may complex with styrene and/or divinyl benzene as shown in FIG. 26 and FIG. 27, respectively. The larger cross-linked reaction products may act as solvents suitable for elemental sulfur (S₈). As a result, lower quantities of styrene and/or divinyl benzene loaded electrolyte are required to similar amounts of polysulfide diffusion control in the electrolyte 130.

FIG. 26 shows an example chemical reaction mechanism 2600 between a MBT and sulfur ion complex 2620 and a styrene group 2630, according to some implementations. The MBT and sulfur ion complex 2620 may react with the styrene group 2630 to create a S-crosslinked styrene dimer 2640 and additional free MBT 2650. The S-crosslinked styrene dimer 2640 may, in some instances, trap polysulfides within pores of, for example, the electrode 300 to prevent such intermediates from entering into the electrolyte 130 of the battery 100 to impede movement of the lithium ions 125.

FIG. 27 shows an example chemical reaction mechanism 2700 between a MBT and sulfur ion complex 2720 and a divinyl benzene (DVB) group 2730, according to some implementations. The MBT and sulfur ion complex 2720 may react with the DVB group 2730 to produce various intermediates prior to yielding a S-crosslinked DVB network 2740 and additional free MBT 2750. The S-crosslinked DVB network 2740 may, in some instances, trap polysulfides within pores of, for example, the electrode 300 to prevent such intermediates from entering into the electrolyte 130 of the battery 100 to impede movement of the lithium ions 125.

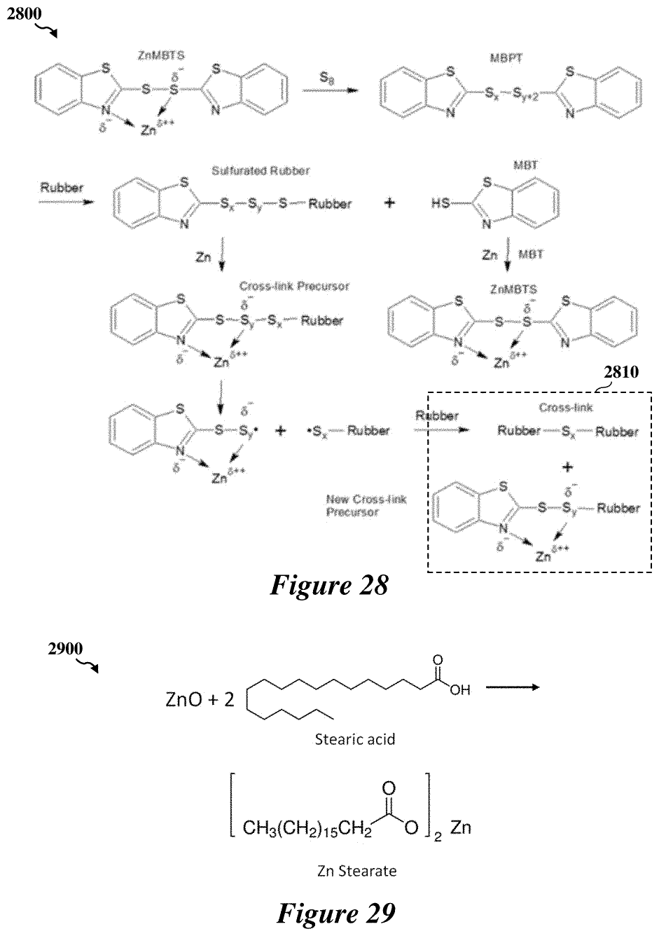

FIG. 28 shows an example chemical reaction mechanism 2800 for the complexation of a zinc (Zn²⁺) ion with 2,2′-Dithiobis(benzothiazole) (MBTS), according to some implementations. Zn based activator compounds may be used in the electrolyte 130 to improve binding efficiency with polysulfides. In some aspects, Zn based activator compounds may decrease the number of additives needed to mitigate polysulfide shuttle. Complex formation between a Zn²⁺ cation and a negatively-charged atom of the MBTS accelerator is shown by the chemical reaction mechanism 2800, which may yield one or more reaction products 2810 that may be incorporated into the electrolyte 130 to improve battery cycling and performance.

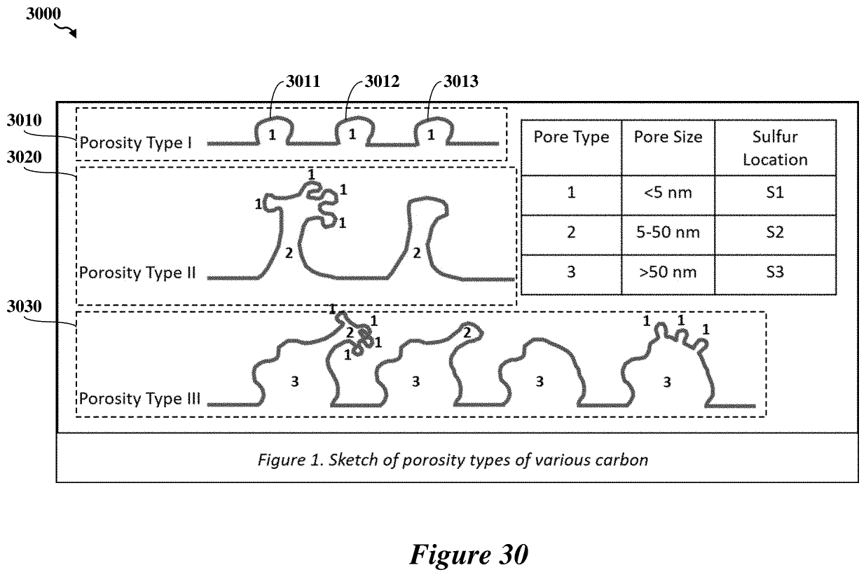

FIG. 29 shows an example chemical reaction mechanism 2900 for the formation of zinc stearate, according to some implementations. Zn activator compounds may be created by incorporation of zinc oxide (ZnO) and a fatty acids (such as one of stearic, lauric, palmitic, oleic, or naphthenic acid). The acids may dissolve ZnO and form a catalyst —Zn carboxylate group, which may yield one or more reaction products that may be incorporated into the electrolyte 130 to improve battery cycling and performance.

FIG. 30 shows a schematic diagram 3000 depicting carbon porosity types of the electrode 300 of FIG. 3, according to some implementations. In some aspects, the electrode 300 of FIG. 3 may be configured as the cathode 110 of the battery 100 of FIG. 1. The electrode 300 may include adjacent aggregates, such as multiple adjacent instances of any two or more of the first aggregates 312 and the second aggregates 322, as shown in the first thin film 310 and the second thin film 320 in FIG. 3. Aggregates may be formed from or include one or more CNOs (or other structured carbonaceous materials disclosed in the present disclosure), where each CNO may be a core-shell structure, such as those shown in FIGS. 9 and 10.

The core-shell structures may join together in, for example, the electrode 300 when configured as the cathode 110, to create any of the porosity types shown in the schematic diagram 3000. For example, the electrode 300 may include any of a porosity type 1 3010, a porosity type II 2030, and a porosity type III 3030. In some implementations, the porosity type 1 3010 may include a first pore 3011, a second pore 3012, and a third pore 3013, all sized with a principal dimension of less than 5 nm to retain polysulfides Some polysulfides may grow in size upon forming larger complexes and become immovably lodged within, for example, pores of the porosity type I 3010. In addition, or the alternative, aggregates may be joined together to create pores of the porosity type II 3020 and/or of the porosity type III 3030 to correspondingly retain polysulfides and/or polysulfides complexed with other chemical molecules as may be needed to mitigate polysulfide shuttling for larger polysulfides and/or complexes.

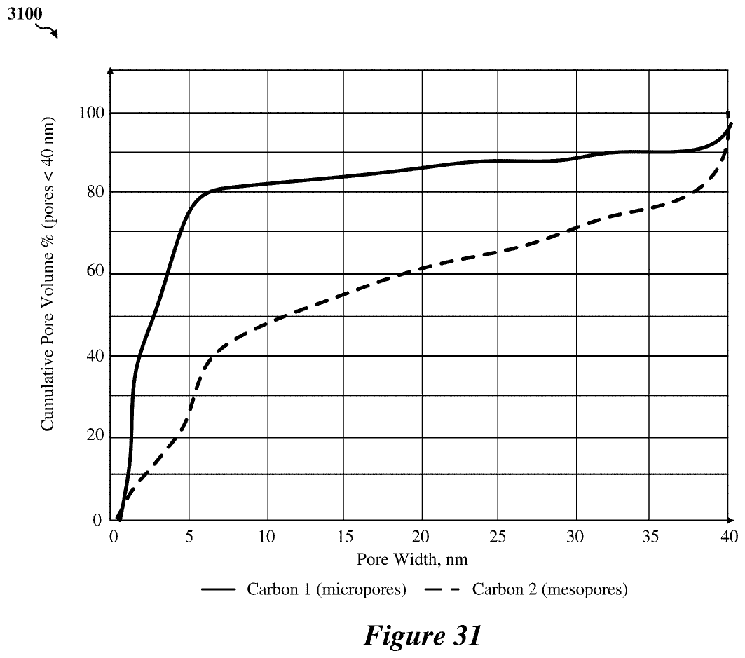

FIG. 31 shows a graph 3100 depicting pore size and distribution of, for example, the electrode 300, according to some implementations. Regarding the graph 3100, “Carbon 1” refers to structured carbonaceous materials featuring predominantly micropores (such as less than 5 nm in principal dimension), and “Carbon 2” refers to structured carbonaceous materials featuring predominantly mesopores (such as between approximately 20 nm to 50 nm in principal dimension). As a result, the electrode 300, in one implementation, may be prepared to have the pore size and distribution depicted in the graph 3100 and correspond to one or more of the electrolytes disclosed herein to improve performance of the battery 100.

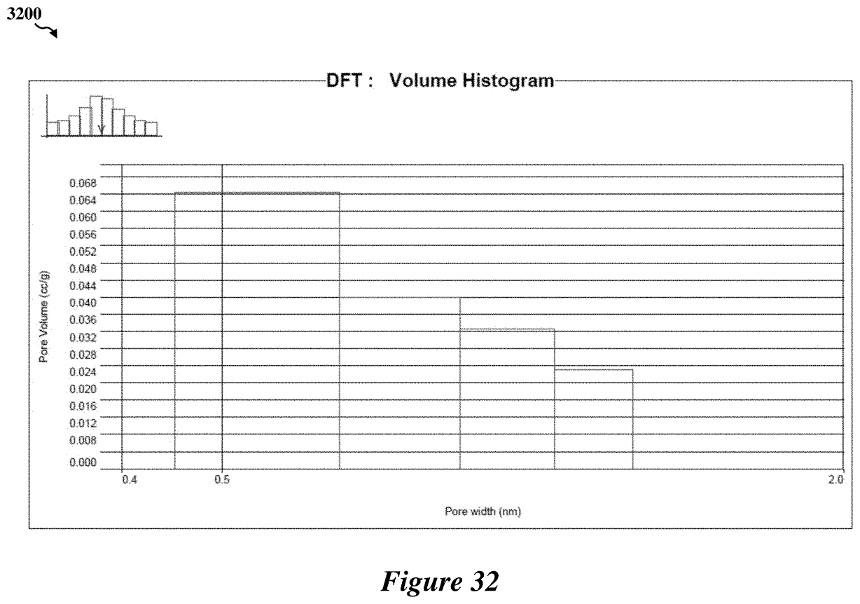

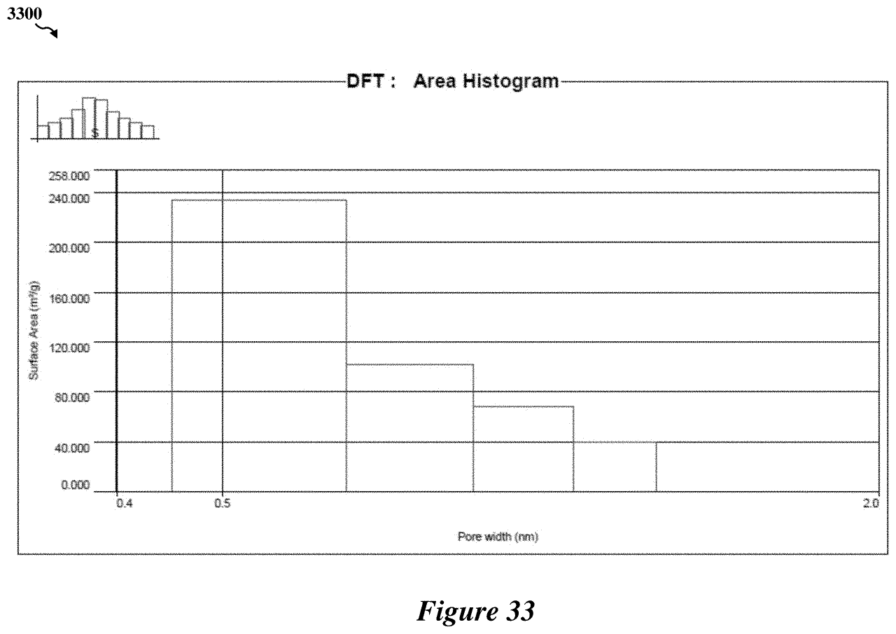

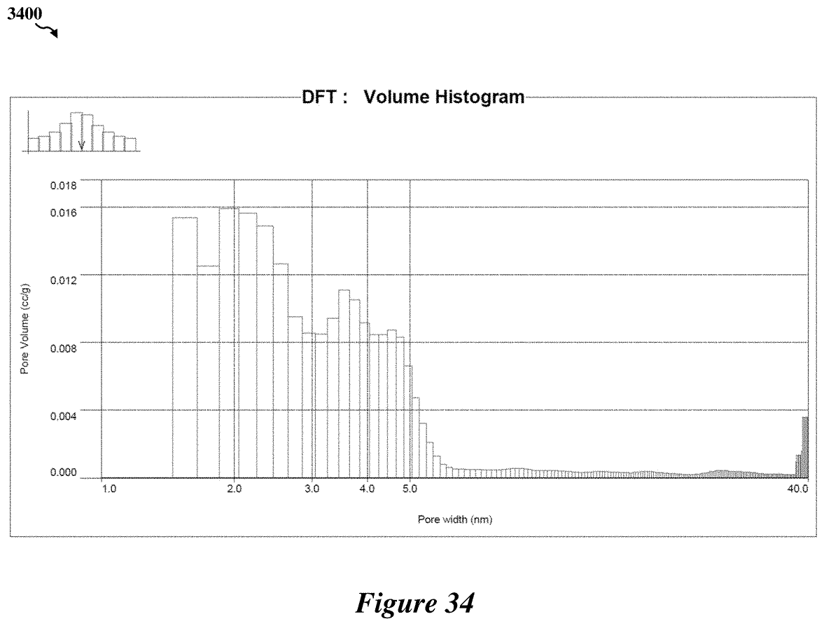

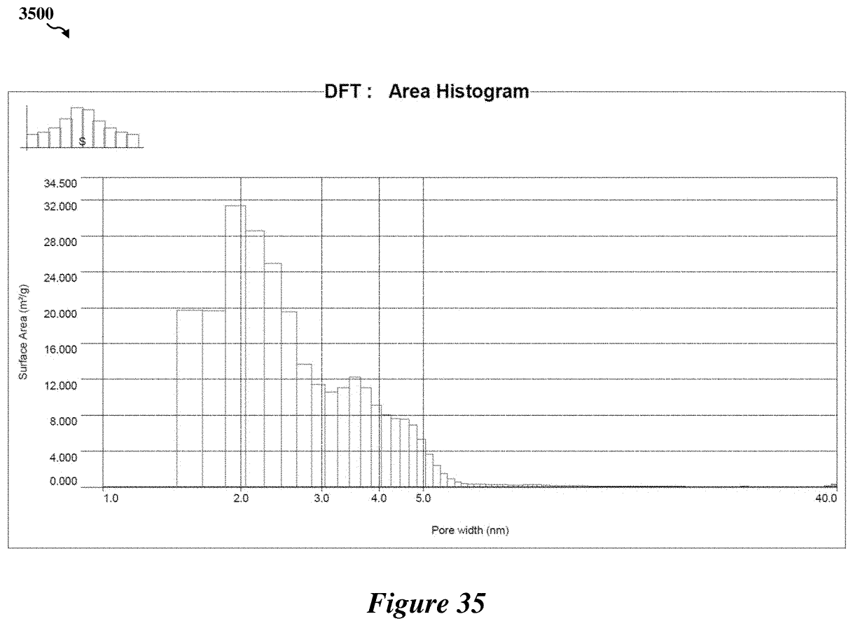

FIG. 32 shows a volume histogram 3200 for pore volume compared against pore width for the cathodes of the battery of either FIG. 1 or FIG. 2, according to some implementations. FIG. 33 shows an area histogram 3300 for surface area compared against pore width for the cathodes of the battery of either FIG. 1 or FIG. 2, according to some implementations. FIG. 34 shows another volume histogram 3400 for pore volume compared against pore width for the cathodes of the battery of either FIG. 1 or FIG. 2, according to some implementations. FIG. 35 shows another area histogram 3500 for surface area compared against pore width for the cathodes of the battery of either FIG. 1 or FIG. 2, according to some implementations. In some implementations, the electrode 300 of FIG. 3 may be prepared to have the physical characteristics, such as pore volume to width distributions and/or the like, shown by the volume histogram 3200 of FIG. 32, the area histogram 3300 of FIG. 33, the volume histogram 3400 of FIG. 34, and the area histogram 3500 of FIG. 35. As a result, the electrode 300, in some implementations, may be prepared to have physical characteristics corresponding to FIGS. 32 to 35 and be tailored to specific corresponding electrolyte chemistries to, for example, yield improved performance of the battery 100.

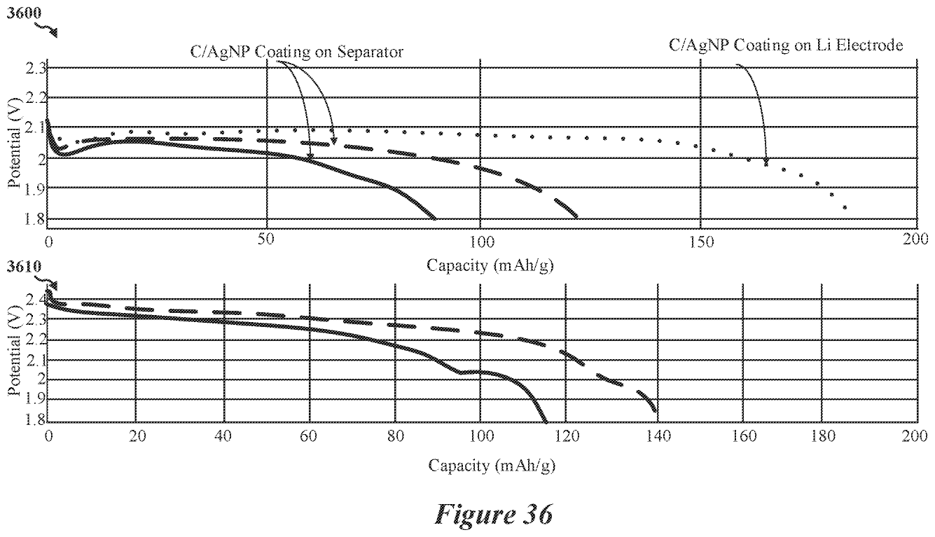

FIG. 36 shows first and second graphs 3600 and 3610 depicting performance of lithium-sulfur electrochemical cells with carbon-silver nanoparticle composite coated components, according to some implementations. For example, the first graph 3600 shows performance of the battery 100 of FIG. 1 over a cycling voltage window of approximately 1.8 V-2.3 V. Over this cycling window, silver decorated carbon nanoparticles coated onto the separator 150 of the battery 100 of FIG. 1 may increase the specific capacity (measured in mAh/g) of the battery 100. Moreover, silver nanoparticles decorating a carbon scaffolded electrode, such as the electrode 300 of FIG. 3, may further increase performance of the battery 100 when combined with other coatings applied to the separator 150. In some aspects, the battery 100 may operate with a voltage window between approximately 1.8 V and 2.3 V, as higher voltage levels may lead to undesirable and/or severe self-discharging resulting from uncontrolled migration of lithium ions 125 and/or polysulfides throughout the battery 100.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above in combination with one another, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

What is claimed is:

1. A lithium-sulfur electrochemical cell comprising:
a cathode including a plurality of regions each defined by two or more core-shell structures adjacent to and in contact with each other;
an anode positioned opposite to the cathode; and
an electrolyte including a ternary solvent package, the electrolyte interspersed throughout the cathode and in contact with the anode.

2. The lithium-sulfur electrochemical cell of claim 1, wherein the ternary solvent package includes one or more of 1,2-Dimethoxyethane (DME), 1,3-Dioxolane (DOL), tetraethylene glycol dimethyl ether (TEGDME), or one or more additives.

3. The lithium-sulfur electrochemical cell of claim 2, wherein the one or more additives includes a lithium nitrate (LiNO₃).

4. The lithium-sulfur electrochemical cell of claim 2, wherein the ternary solvent package further comprises 5,800 microliters (μL) of DME, 2,900 microliters (μL) of DOL, and 1,300 microliters (μL) of TEGDME.

5. The lithium-sulfur electrochemical cell of claim 4, wherein the ternary solvent package includes approximately 0.01 mol of dissolved lithium bis(trifluoromethanesulfonyl)imide (LiTFSI).

6. The lithium-sulfur electrochemical cell of claim 5, wherein the ternary solvent package is at a first approximate dilution level of 1 molar (M) LiTFSI in DME:DOL:TEGDME.

7. The lithium-sulfur electrochemical cell of claim 6, wherein the ternary solvent package is at a second approximate dilution level of approximately 1 M LiTFSI in DME:DOL:TEGDME at a volume ratio of volume:volume:volume=58:29:13 and including 2 weight percent (wt. %) lithium nitrate.

8. The lithium-sulfur electrochemical cell of claim 1, wherein the plurality of regions includes an elemental sulfur.

9. The lithium-sulfur electrochemical cell of claim 8, wherein the ternary solvent package has a tunable polarity and a tunable solubility.

10. The lithium-sulfur electrochemical cell of claim 8, wherein the ternary solvent package includes ions.

11. The lithium-sulfur electrochemical cell of claim 8, wherein the ternary solvent package includes polysulfides.

12. The lithium-sulfur electrochemical cell of claim 1, wherein the anode is a graphitic scaffold.

13. The lithium-sulfur electrochemical cell of claim 12, wherein the graphitic scaffold comprises a plurality of graphene sheets stacked vertically, at least some adjacent graphene sheets including a plurality of lithium ions.

14. The lithium-sulfur electrochemical cell of claim 13, wherein the graphitic scaffold further comprises a lithium-intercalated graphite (LiC₆) based on the plurality of lithium ions.

15. The lithium-sulfur electrochemical cell of claim 1, wherein the plurality of regions includes a plurality of polysulfides generated during an operational cycling of the lithium-sulfur electrochemical cell.

16. The lithium-sulfur electrochemical cell of claim 15, wherein the plurality of polysulfides are suspended within the electrolyte.

17. The lithium-sulfur electrochemical cell of claim 1, wherein the cathode includes a plurality of flexure points.

18. The lithium-sulfur electrochemical cell of claim 17, wherein the plurality of flexure points encompass several of the regions.

19. The lithium-sulfur electrochemical cell of claim 1, wherein each core-shell structure is a carbon nano-onion (CNO).

20. The lithium-sulfur electrochemical cell of claim 19, wherein each CNO comprises:
an outer shell region having a first carbon density; and
a core region positioned within an interior region of the outer shell region and having a second carbon density lower than the first carbon density.

21. The lithium-sulfur electrochemical cell of claim 20, wherein the first carbon density is between approximately 0.1 grams per cubic centimeter (g/cc) and 2.3 g/cc.

22. The lithium-sulfur electrochemical cell of claim 20, wherein the second carbon density is between approximately 0.0 g/cc and 0.1 g/cc, between approximately 0.1 g/cc and 0.5 g/cc, between approximately 0.6 g/cc and 1.0 g/cc, between approximately 1.1 g/cc and 1.5 g/cc, between approximately 1.6 g/cc and 2.0 g/cc, between approximately 2.1 g/cc and 2.3 g/cc, or any combination thereof.

23. The lithium-sulfur electrochemical cell of claim 20, wherein the plurality of regions further comprises a plurality of microporous channels, a plurality of mesoporous channels, and a plurality of macroporous channels.

24. The lithium-sulfur electrochemical cell of claim 23, wherein at least some of the plurality of microporous channels, the plurality of mesoporous channels, and the plurality of macroporous channels connect with each other and form a porous network extending from the outer shell region to the core region.

25. The lithium-sulfur electrochemical cell of claim 24, wherein the porous network comprises a plurality of pores, wherein at least some of the pores have a principal dimension of approximately 1.5 nm.

26. The lithium-sulfur electrochemical cell of claim 1, further comprising a separator positioned between the cathode and the anode.

27. The lithium-sulfur electrochemical cell of claim 26, wherein the separator is coated with one or more of a ceramic-containing compound or an aluminum fluoride containing mixture.

28. The lithium-sulfur electrochemical cell of claim 27, wherein the separator is porous and includes a plurality of pores.

29. The lithium-sulfur electrochemical cell of claim 1, further comprising an artificial solid-electrolyte interphase formed on the anode in response to operational cycling of the lithium-sulfur electrochemical cell.

30. The lithium-sulfur electrochemical cell of claim 1, further comprising a barrier layer including a mechanical strength enhancer coated on the anode.
